(19) United States
(12) Patent Application Publication
(10) Pub. No.: US 2020/0299195 A1
(43) Pub. Date: Sep. 24, 2020

(54) Salt Inert/Resistant Barrier Compositions and Their Industrial Application

(71) Applicant: Westmoreland Advanced Materials, Inc., Charleroi, PA (US)

(72) Inventors: Kenneth A. McGowan, Harrison City, PA (US); Robert M. Cullen, Bethel Park, PA (US)

(21) Appl. No.: 16/822,998

(22) Filed: Mar. 18, 2020

Related U.S. Application Data
(60) Provisional application No. 62/820,470, filed on Mar. 19, 2019.

(51) Int. Cl. C04B 35/10; C04B 35/66; C04B 35/057; C04B 35/44; C04B 35/04

(52) U.S. Cl. CPC C04B 35/10; C04B 35/66; C04B 35/057; C04B 35/44; C04B 35/04; C04B 2235/3208; C04B 2235/9692; C04B 2235/3217; C04B 2235/3222; C04B 2235/422; C04B 2235/445; C04B 2235/48; C04B 2235/3206

(57) ABSTRACT

The present invention provides for a solid body composition that is able to withstand penetration and/or reaction with salts or salt compositions in one or more states of matter (solid, liquid, gas). The composition comprises at least one aggregate and at least one binder. The aggregate may be chosen based on its thermodynamic stability compared to a salt composition. The binder comprises a resol resin or a novolac resin, or a combination of one or more of a resol resin and one or more of a novolac resin. The resin binder sets to provide initial strength then is pyrolized to form a glassy carbon which acts as a barrier to a salt phase or phases of an industrial process.

### CROSS-REFERENCE TO RELATED APPLICATION

This patent application claims the benefit of co-pending U.S. Provisional Patent Application Ser. No. 62/820,470, filed Mar. 19, 2019. The entire contents of U.S. Provisional Patent Application Ser. No. 62/820,470 is incorporated by reference into this patent application as if fully written herein.

### STATEMENT REGARDING FEDERALLY SPONSORED RESEARCH OR DEVELOPMENT

Not applicable.

### BACKGROUND OF THE INVENTION

### 1. Field of the Invention

The present invention provides a barrier system for salt, salt mixtures, salt reaction products and salt reaction by-products present in either or all forms of solid, liquid, and gas phase. The barrier system will operate at temperature greater than 325° C. (Centigrade) without loss of physical integrity. Under inert or reducing conditions, the system can operate up to 1750° C. without loss of physical integrity. Under oxidizing conditions, the system can operate up to 800° C. without loss of physical integrity. The barrier system is comprised of a distribution of various sized aggregate that is bonded together with a phenolic based resin/resin blend. Initiation of the polymerization reaction in the resin/resin blend can be accomplished via a chemical initiator, a photochemical initiation (meaning initiation by exposure to part of the electromagnetic spectrum, for example IR) or by an environmental change such as the application of heat or pressure. Phenolic based resin/resin mixtures are specifically chosen to provide temperature resistance as previously describe. Phenolic resin/resin mixtures will form glassy-like carbon (aka glassy carbon [trademarked term]) with the application of temperature. This allows the resin/glass like carbon to maintain structural integrity at temperatures up to 1750° C. in inert or reducing conditions or up to 800° C. in oxidizing conditions. The resins/glassy like carbon will form an impermeable barrier to salt in either solid, liquid or gaseous form. The amount or concentration of resin to be used in the barrier system is based on a space filling model which will be described herein. The concentration of the resin used is high enough to fill empty voids between the bonded aggregate so that the barrier system essentially has no interconnected porosity or low interconnected porosity from one side of the barrier to the other side of the barrier. The aggregate which is bound by the resin/resin mixture is chosen based on its chemical compatibility (as defined by reaction kinetics and relative thermodynamic stability) with the salt/salt mixture, salt reaction products and by-products. It is (also-remove) chosen based on its relative Gibbs free energy of formation compared to the salt/salt mixture, salt reaction products and by-products. It is also chosen to impart/provide desired physical properties to the barrier system as a whole.

### 2. Description of the Background Art

Salts and salt mixtures as solids, liquids, gases or mixtures of these physical states are used or are encountered in the processing of materials in a variety of industrial applications. For example, in an electrolysis process, in order to put alumina into solution so the Hall-Heroult process can proceed, a cyrolite based salt in combination with other salts such as NaF is used as a solvating compound in its liquid state. This can be done with other metals that cannot be reduced by traditional oxidation-reduction reactions because of excessively high temperature requirements or the need to produce ultra-high purity metals. In certain other electrochemical processes, solid metals and/or alloys are created by reducing metal oxides in a molten salt solution. In the paper whitening process, NaOH and KOH are used to dissolve and remove wood lignan and other organic compounds from pulp. This results in a by-product called black liquor which is then recycled in a boiler or other process for reuse. In many non-ferrous metal processing applications, a flux, which is a specific mixture of salts, is used to purify metals by reacting with specific impurities in a liquid or semi-solid state to form new complexes that can be separated from the desired metal by density differences or other physical separation technologies. In the energy sector salts are becoming more and more used as storage media, such as in lithium ion batteries, to heat exchange/storage media in the case of Generation IV nuclear reactors and solar energy fields. In some cases, salts are formed as byproduct of processes such as in the case of petrochemical refining where gaseous sulfur compounds can react with a variety of components of the processing stream to form sulfates, sulfites, sulfides and even acid, which degrade the processing components and equipment.

All of these processes require some means of containing the added, processed or formed salt complexes and their often-present acid and base byproducts. These can be in the form of gases, liquids and solids or as often is the case, multiple salts in multiple physical forms.

The containment issue become more complex as many of the industrial processes described above occur at elevated temperatures greater than 325° C. Some metallics are processed at temperatures approaching 1600° C. At these temperatures most salts and salt complexes are in a liquid or gas state. Many salts sublime, meaning they go directly from a solid to gas state. Containing a liquid or gaseous material is significantly more difficult compared to a solid material. Furthermore, at temperatures above 325° C. many materials used to contain salts such as polymers and glasses will melt or otherwise thermally decompose or detrimentally react, thereby losing the physical integrity necessary to provide containment.

At these higher temperatures metallics and/or mixed metallic/ceramic compositions are often used as barriers. Alloys with high Ni can Cr can have melting points exceeding 1300° C. Cermet (contraction of ceramic and metallic) are usually comprised of a combination of a ceramic and a sintered metal. These have the benefit of heat resistance and plastic deformation. Ceramics provide very high heat resistance but are typically quite brittle.

High temperature alloys are able to handle high temperature environments and are typically oxidation/corrosion resistant. They are center faced cubic which is a simple geometry and minimizes the exposure of grain boundaries, which is where oxidation and corrosion begins. Where oxygen is the major reactive component, these alloys work very well at high temperature where even some stainless steels will show rapid oxidation. However, in contact with a high concentration of salts, particularly the halides. The halide will eventually penetrate the grain boundary and begin the corrosion/oxidation process. Furthermore, the reaction rate increases with increasing temperature and/or the presence of water which results in the formation of the halide acids. Therefore, utilizing these superalloys as a long-term containment solution at elevated temperatures is not ideal.

Cermets provide improved corrosion/oxidation resistance since a large component of the composition is typically ceramic in the form of nitrides, carbides or carbonitrides. At low temperatures or under reducing conditions the carbides, nitrides and carbonitrides are resistant to corrosion/oxidation. At higher temperatures these compounds will often easily oxidize in the presence of oxygen. Therefore, they should preferably be used in reducing or inert atmospheres at elevated temperatures. The metallic component of the composition is also susceptible to corrosion/oxidation similar to the superalloys. However, specific non-ferrous metallics such as Tungsten, Nickle, Chrome and even Gold and Platinum can be utilized to reduce the corrosion/oxidation potential. However, the associated costs of producing such materials can be prohibitive. Furthermore, at high temperatures, salts will be present in a gaseous state. The gas can be comprised of the salt or salts, or it may be a reaction product such as an oxide such as various hypochlorites, hydrochloric acid or even chlorine in the case of chloride salts. When the salt or salt component is in gaseous form, containment in traditional systems become almost impossible. The high temperature systems such as cermets and ceramics are structures which contain a significant amount of open porosity. Although the porosity present may be on a microscopic scale, it is easily penetrated by the gas molecules of the salt or salt component. In this case, the gas will travel to an area of lower concentration. Being a high temperature environment, the containment system will not be at thermal equilibrium. Typically, the inner portion of the containment system will be at an elevated temperature while the outer portion will be at a lower temperature. This creates a temperature gradient within the containment wall. The gas will move from the high concentration are in the system to the low concentration area at the outside of the containment system. At some point either in the wall of the containment system itself or at the outside surface of the containment system, the gas will be exposed to a temperature at or below its freeze/boiling point. The salt will then change to the corresponding solid or liquid. If solidification occurs internal to the barrier composition, the formation of solid salt is often expansive, and it will disrupt the matrix of the barrier material and cause a structural failure. If it succeeds in exiting the barrier in the gas or liquid phase, the containment system has failed. In several industrial applications, such as certain purification processes for aluminum processing and recycling, chlorine gas is introduced into the system in order to react with impurities in the molten metal. In this case, chloride salts form that either float to the top of the melt or sink to the bottom of the melt, which make them easy to remove. A major issue with the effective purification process is the fact that chlorine is poisonous. It also readily attacks the containment system by also causing the formation of chlorides which physically disrupt the matrix of the containment system. Great care must be taken to ensure that no chlorine gas is allowed to escape to the environment and these containment systems are constantly monitored and replaced to keep the workspace safe. This is a case where a non-salt gas is introduced which forms various salts that attack or damage the ceramic containment system as a result of the ceramic systems inherent porosity.

The intent of this background discussion is to provide a brief description of the expanding use of salts, salt forming systems and salt reaction by-products such as acids and bases, either or aqueous and non-aqueous. Furthermore, the need for containment of these systems at temperatures exceeding 325° C. where standard polymeric systems and dense glass systems fail due to loss of physical integrity due to melting/softening and/or thermal decomposition. It is also intended to discuss the current technology and the failure mechanisms of these systems which prohibit them from being considered long term containment solutions, especially for the liquid and gas forms of the salts, salt reaction products, and by products. This primarily being grain boundary attack with subsequent corrosion/oxidation of alloys, the issues with inherent porosity of cermet and/or ceramic systems and the expensive of low or non-reactive metallics such as gold or platinum.

Phenolic resins are currently used as a binding system for some refractory application. One application is in magnesium carbon brick that are used in the steel making process. In this case, the resins are typically heat set resins that are blended into a brick mix. This mix may contain other ‘initial binders’ which provide ‘green strength’ so the brick can be handled when removed from the press. The resin provides a later and permanent bond during a process where the brick is heat treated in a kiln. The brick is then ‘laid up’ into a containment structure for the molten steel and slag. In this case, the brick contains some open porosity and therefore they are not sealed against gases penetration. Furthermore, the joints between the brick also allow for penetration of gases and eventually the liquid steel attacks these areas creating a cobblestone effect. For this reason, some of the brick can be as long as 1 meter in length (from inside to outside). In order to eliminate porosity sometimes the bricks are impregnated with a liquid tar. This seals the porosity but is not an ideal solution for lower temperature processes, such as discussed above, where a significant amount of organic molecules in the tar will volatilize. Steel making processes can range from 1450° C. up to 1700° C. At these temperatures, volatile organics are thermally oxidized primarily to CO₂ and H₂O.

Another application where resin/resin mixtures are used to bind an aggregate is as a sacrificial, lightweight lining for a tundish ladle. In this case, the aggregate/resin blend is fed behind a mold/mandrel in a tundish. The material is then heated to set the resin. The mold/mandrel is then pulled. Behind the sacrificial lining is a permanent refractory backup/safety lining. When steel is processed through the tundish the lining acts as a thermal barrier holding in much more heat than the backup would allow on its own. As the resin is oxidized due to the high temperature and presences of oxygen the released aggregate floats on the top of the liquid steel and is therefore kept out of the metal. Typical refractory would be denser than the steel and pieces lost during production can become inclusions within the solidified product. This is very undesirable. In any case, the lining has a significant amount of porosity and is not impermeable to gases. The lifetime of the lining is several casts, upon which time it is easily removed, and a new lining is installed.

Although at steel making temperatures the salt mix/mixtures discussed would not survive. However, if the brick or tundish lining were used as a containment system for salt/salt mixtures, they would fail due to the fact that they do posses open porosity. In the case of bricks, they would require joints to create a structure which would be susceptible to liquid and gas phase salt attack. The aggregate making up the tundish lining is also not compatible with salt/salt mixtures since it is typically a low-cost alumina containing mineral composition that contains a significant amount of impurities which would react with the salt/salt mixture being contained.

Therefore, a very real, growing and substantial need for a barrier system designed to contain salts, salt forming systems and salt reaction by-products such as acids and bases, either or aqueous and non-aqueous is needed. A system which is comprised of an aggregate bonded by a phenolic resin/resin mixture that is chemically compatible with the materials being contained, is energetically stable at the necessary process temperatures and will provide the physical and engineering attributes necessary to design and build the structure represents a solution to this technical challenge.

### SUMMARY OF THE INVENTION

The present invention provides a barrier system composition comprising a phenolic resin or resin mixture in combination with an aggregate. The resin or resin mixture will polymerize (set) when appropriately initiated. This process will bind the aggregate particles. The ‘set’ resin or resin mixture will convert or form into glassy-like carbon at elevated temperature, whereas any volatile organic component will leave the system (evaporate) or will be removed via thermal decomposition during this process. This glassy material is comprised primarily of polymerized aromatic ring structures. The glassy like carbon is impervious to, and sufficiently inert in contact with solid, liquid and/or gas phases of the salt/salt mixtures. The ideal temperature which the barrier system should be treated, prior to process containment, should be a temperature greater than the maximum expected process temperature to which the system will be exposed. This will ensure no temperature induced changes will occur in the barrier system. The ‘set’ resin will encase a distribution of aggregate. In a preferred embodiment of this invention, the barrier system will not have any open porosity between the inside of the structure to the outside of the structure. However, it is likely there will be a small amount of open porosity and this is to be limited as much as possible. There may be closed porosity within the ‘set’ resin/resin mixture. There may be open and closed porosity within the aggregate. Any open porosity within the aggregate will be sealed at the surface by the resin/resin mixture. Choice of aggregate is discussed in the Detailed Description section herein. The polymerized resin will not work without the use of an aggregate. This is primarily due to two issues. The first is the resin will lose mass and volume with increasing temperature. This makes it impossible to use as a barrier without prior thermal treatment and shaping. e.g. it would need to be a pre-engineered shape in order to create a barrier structure. Second, the pure resin systems are susceptible to thermal shock and more importantly cyclic thermal conditions. In these cases, they tend to fracture and crack which reduces lifetime. When used in combination with aggregate, the aggregate imparts thermal shock and cycling resistance as a result of differential thermal expansion. This prestresses the structure. The aggregates described in this application/compositions are also mass and volume stable within the temperature ranges of interest.

The present invention provides a composition comprising at least one aggregate and at least one phenolic resin, wherein said phenolic resin is pyrolyzed to result in the formation of a condensed ring glassy carbon, wherein said glassy carbon is a bonding matrix of the resulting composition. Preferably, the composition of the present invention includes wherein said aggregate is at least one selected from the group consisting of LiF, ZrF₄, MgF₂, KF, MnF₂, NaF, YF₃, BaF₂, CaF₂, BaO, Al₂O₃, SiO2, CaO, TiO₂, Ti₂O₅, Ti₂O₃, TiO, ZrO₂, Y₂O₃, MgO carbon compounds, graphite, SiC, B₄C (B₁₂C₃), WC, AlN, BN, a rare earth oxide, an alkali halide, and an alkaline halide, and combinations thereof. A preferred embodiment of this composition is wherein the aggregate is CaO plus Al₂O₃, and more preferably the aggregate is one of CaO-2Al₂O₃ (CaAlO₄), CaO—Al₂O₃, or CaO-6Al₂O₃, or combinations of one or more of CaO-2Al₂O₃ (CaAlO₄), CaO—Al₂O₃, and CaO-6Al₂O₃.

Another embodiment of this invention provides wherein the composition, as set forth herein, includes wherein said aggregate is a mixture of at least two or more of said aggregates.

Another embodiment of this invention provides a composition, as described herein, includes wherein the aggregate is an alkali halide that is at least one selected from the group consisting of LiCl, NaCl, and KCl, and corresponding fluoride (F), bromide (Br), or iodide (I) salts.

Another embodiment of this invention provides wherein the composition, as set forth herein, includes wherein the aggregate is at least one selected from the group consisting of LiF, ZrF₄, MgF₂, KF, NaF, YF₃, BaF₂, and CaF₂.

In another embodiment of this invention, the composition, as set forth herein, includes wherein the resin is at least one selected from the group consisting of a novolac resin, a resol resin, or a combination of a mixture of a novolac resin and a resole resin. Preferably, the resin is a cross-linked phenolic resin. More preferably, the resin is a cross-linked and pyrolyzed phenolic resin.

In yet another embodiment of this invention, a method is provided for establishing a chemical and thermal barrier in a structure comprising lining a structure with a composition comprising at least one aggregate and at least one phenolic resin, wherein said phenolic resin is pyrolyzed to result in the formation of a condensed ring glassy carbon, wherein said glassy carbon is a bonding matrix of the resulting composition, wherein said composition forms a chemical and thermal barrier in said structure, wherein said structure is used in a process utilizing high temperature salts, said high temperature salts in a liquid and/or gas form, and wherein said process comprises a corrosive, acidic or basic process environment. The aggregates and resins used in this method are as described herein. Preferably, this method includes wherein the glassy carbon protects the aggregate from the salt and corrosive environment of the process.

### BRIEF DESCRIPTION OF THE DRAWINGS

FIG. 1 shows an Ellingham diagram of standard Gibb's energies of formation for selected bromides. All Ellingham diagrams herein, Stanley M. Howard, S D School of Mines and Technology, Internet Resource for MET 320-Metallurgical Thermodynamics.

FIGS. 2A, 2B, 2C, 2D, and 2E show Ellingham diagrams of standard Gibb's energies of formation for selected chlorides.

FIGS. 3A, 3B, 3C, 3D, and 3E show Ellingham diagrams of standard Gibb's energies of formation for selected fluorides.

FIGS. 4A, 4B, and 4C show Ellingham diagrams of standard Gibb's energies of formation for selected hydrides.

FIGS. 5A and 5B show Ellingham diagrams of standard Gibb's energies of formation for selected iodides.

FIG. 6 shows an Ellingham diagram of standard Gibb's energies of formation for selected nitrides.

FIGS. 7A, 7B, 7C, 7D, 7E, 7F, and 7G show Ellingham diagrams of standard Gibb's energies of formation for selected oxides.

FIGS. 8A, 8B, and 8C show Ellingham diagrams of standard Gibb's energies of formation for selected sulfides.

FIG. 9 shows an Ellingham diagram of standard Gibb's energies of formation for selected selenides.

FIGS. 10A and 10B show Ellingham diagrams of standard Gibb's energies of formation for selected tellurides.

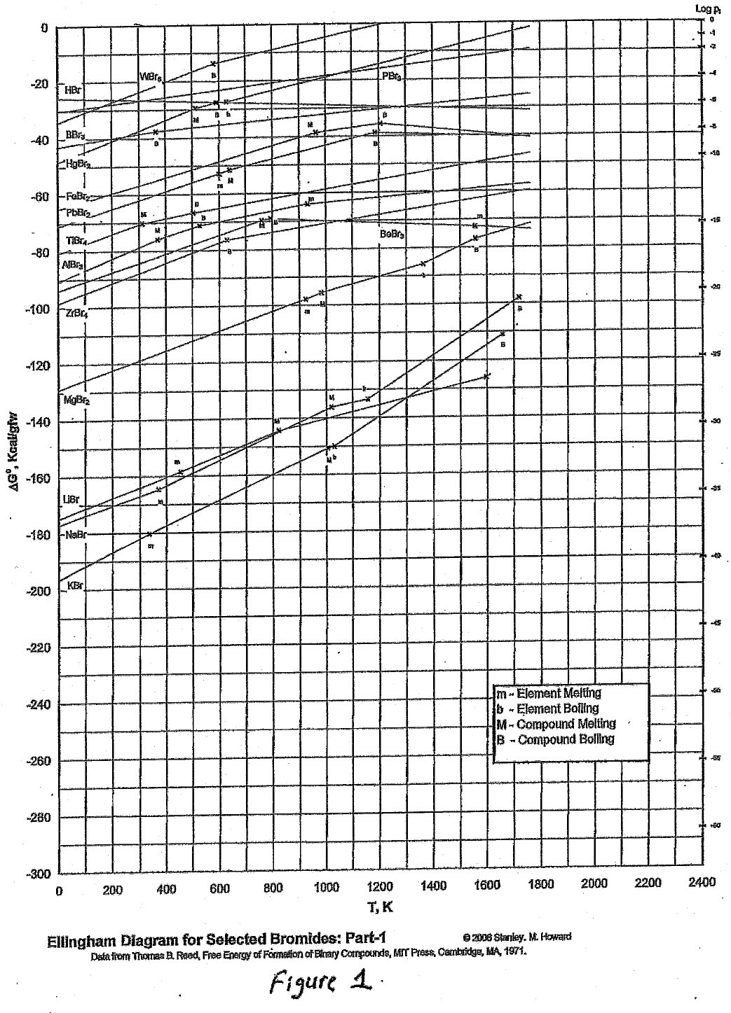

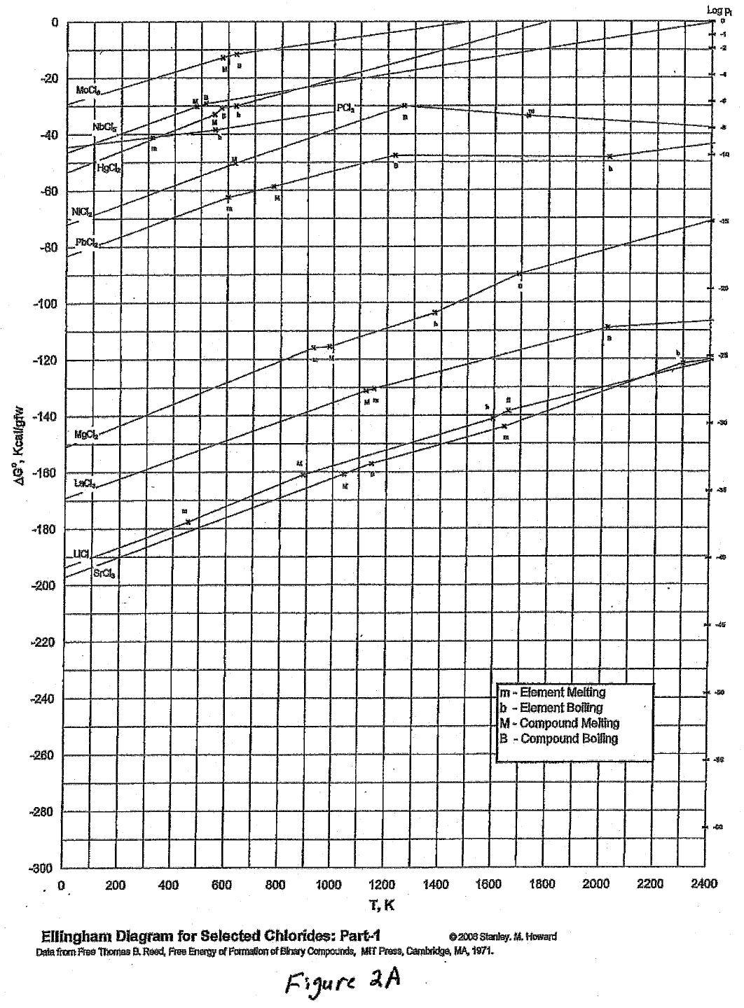

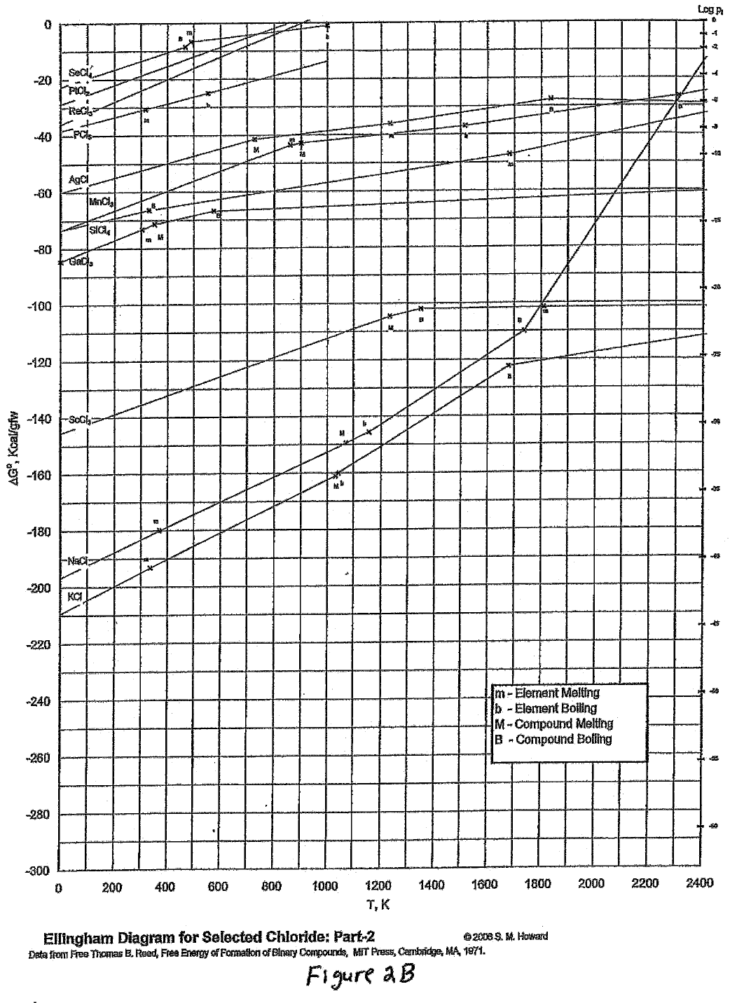

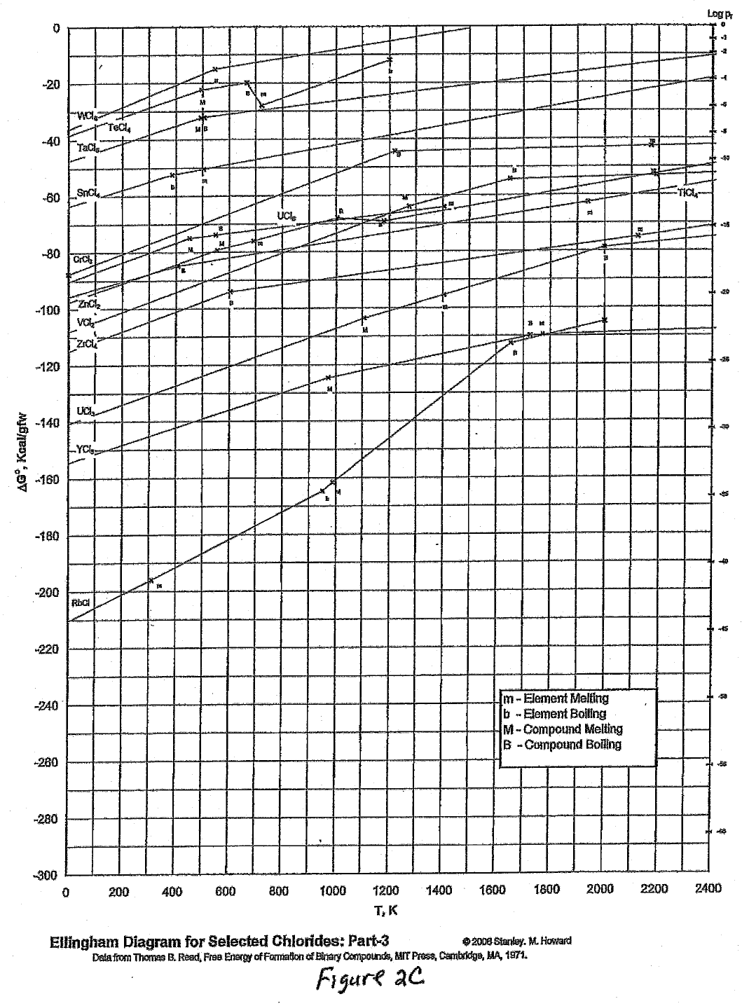

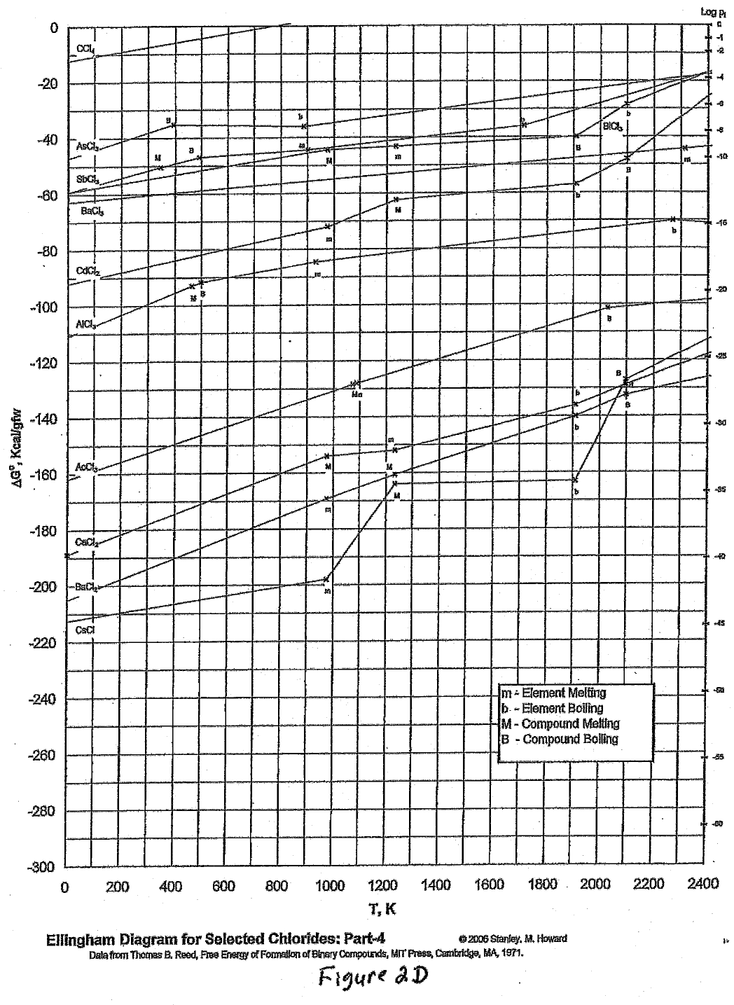

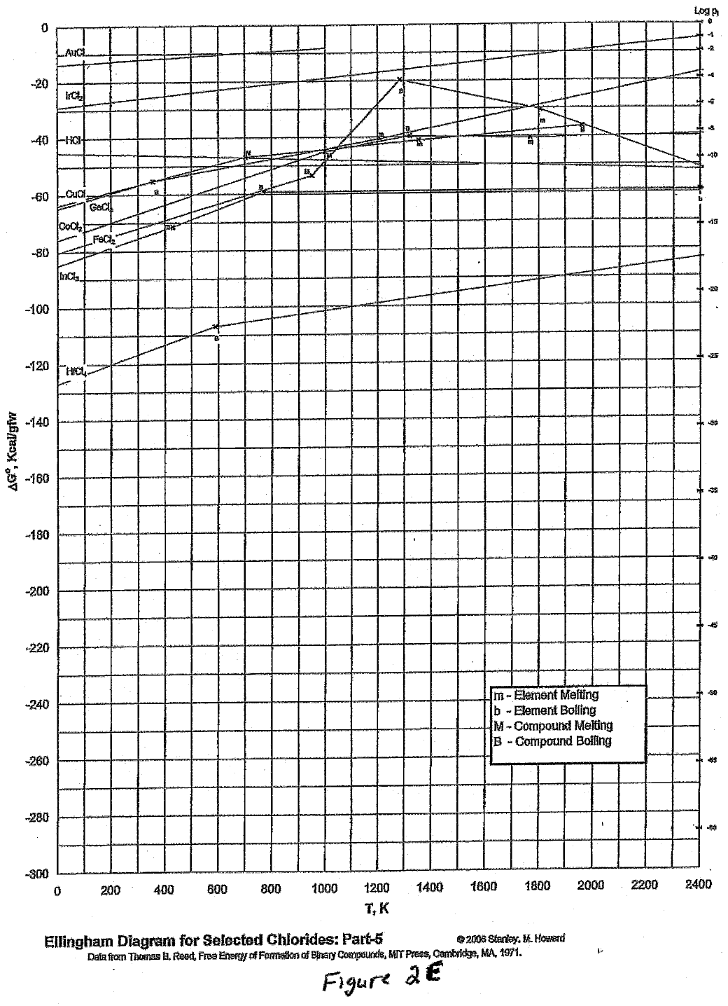

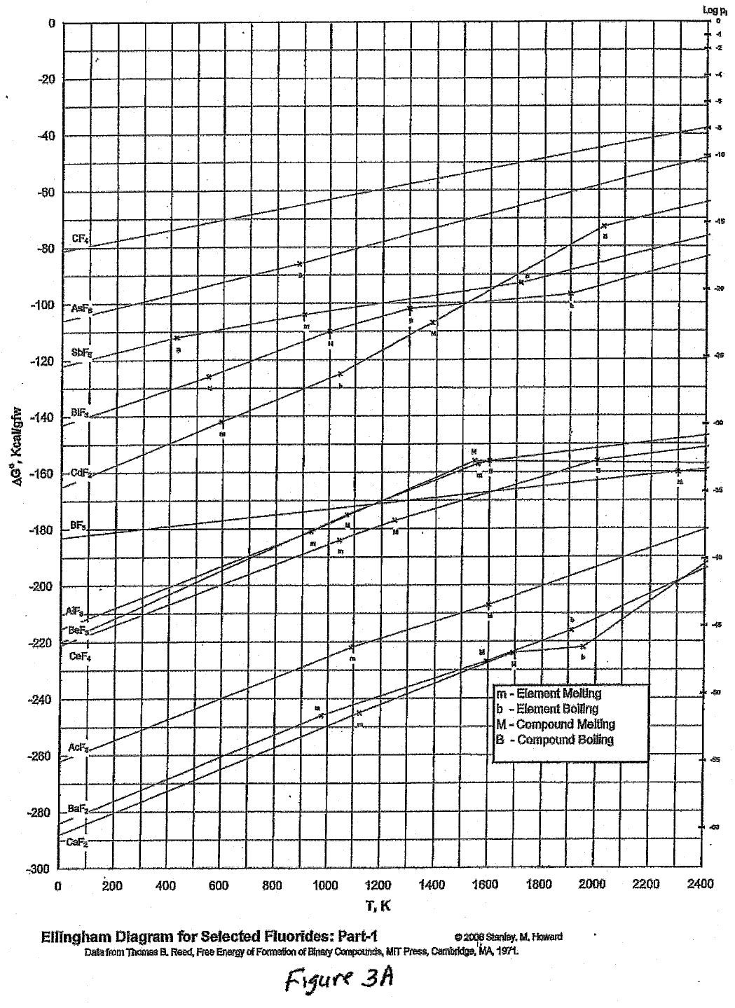

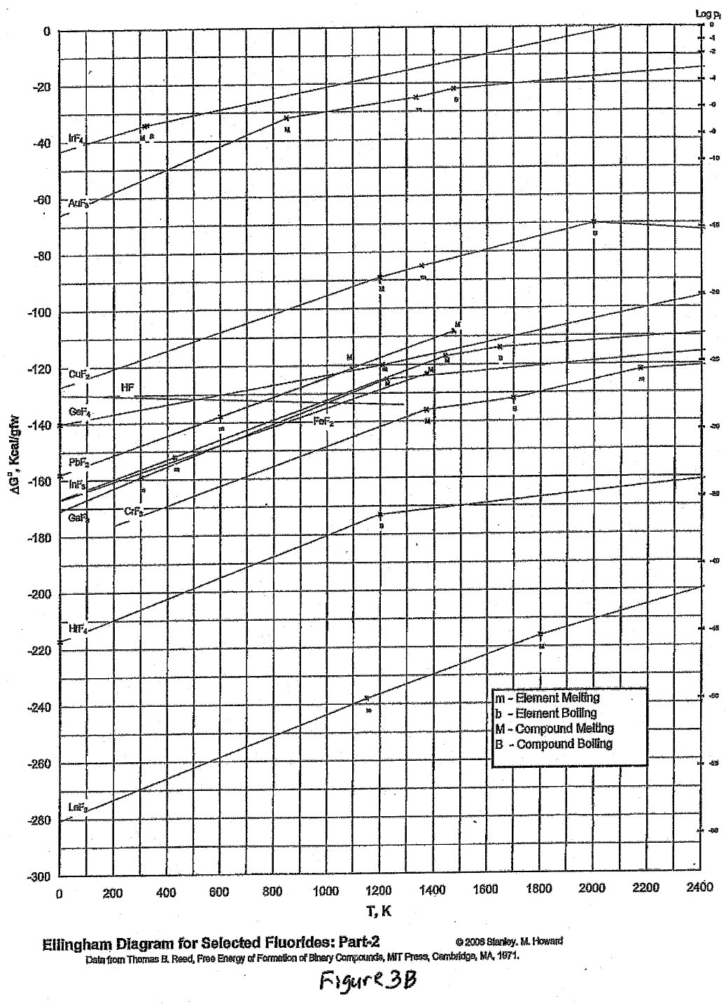

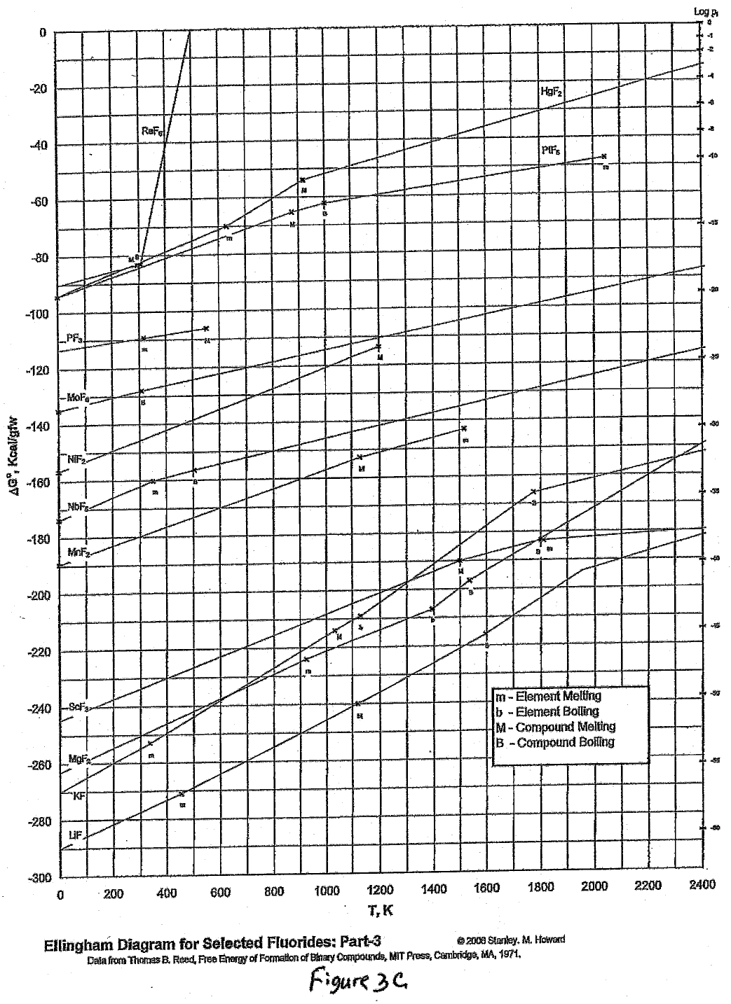

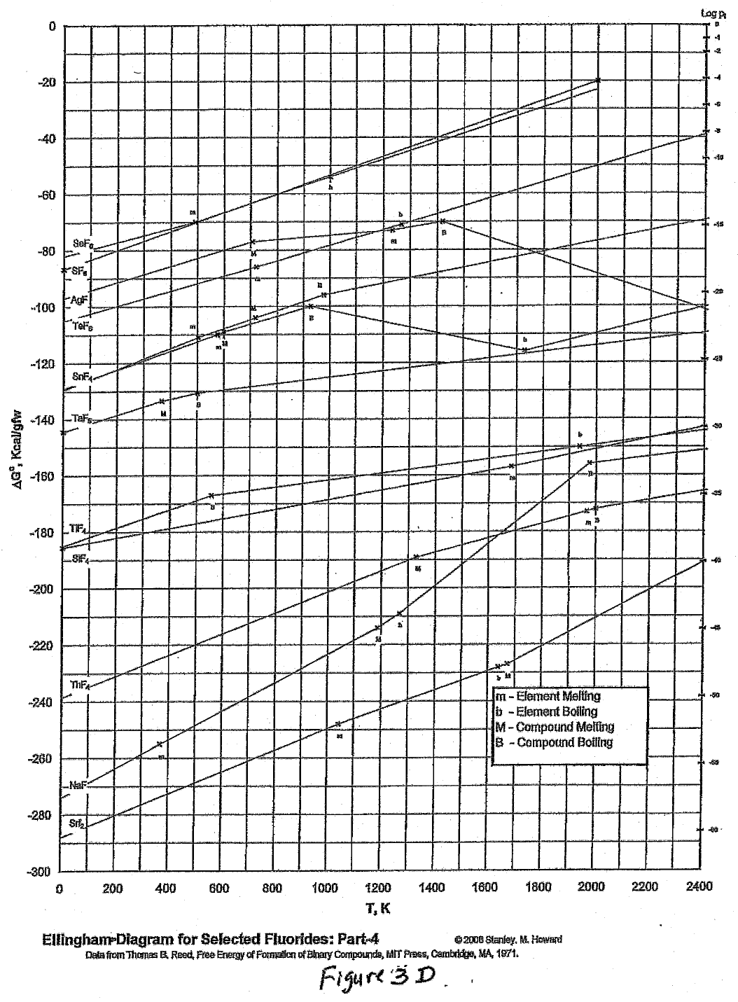

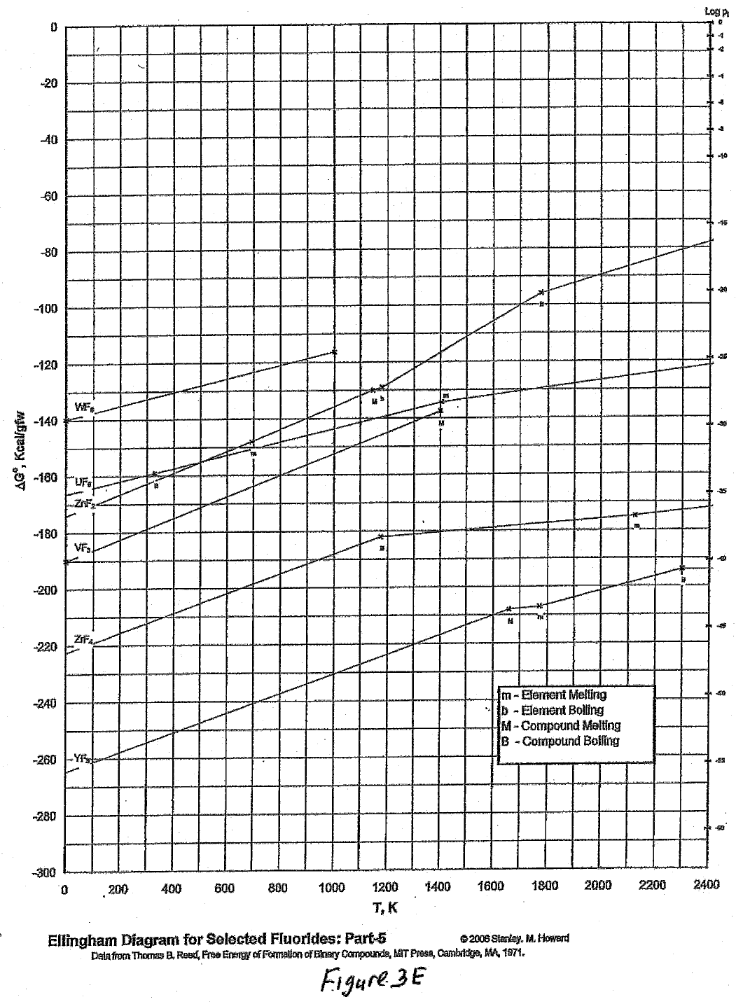

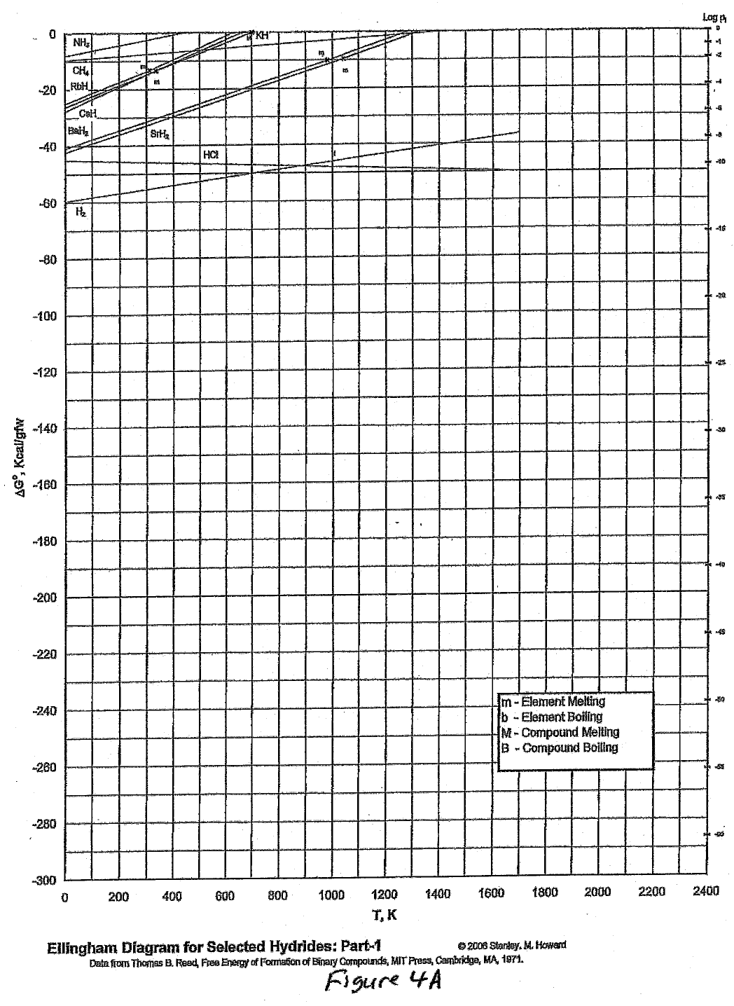

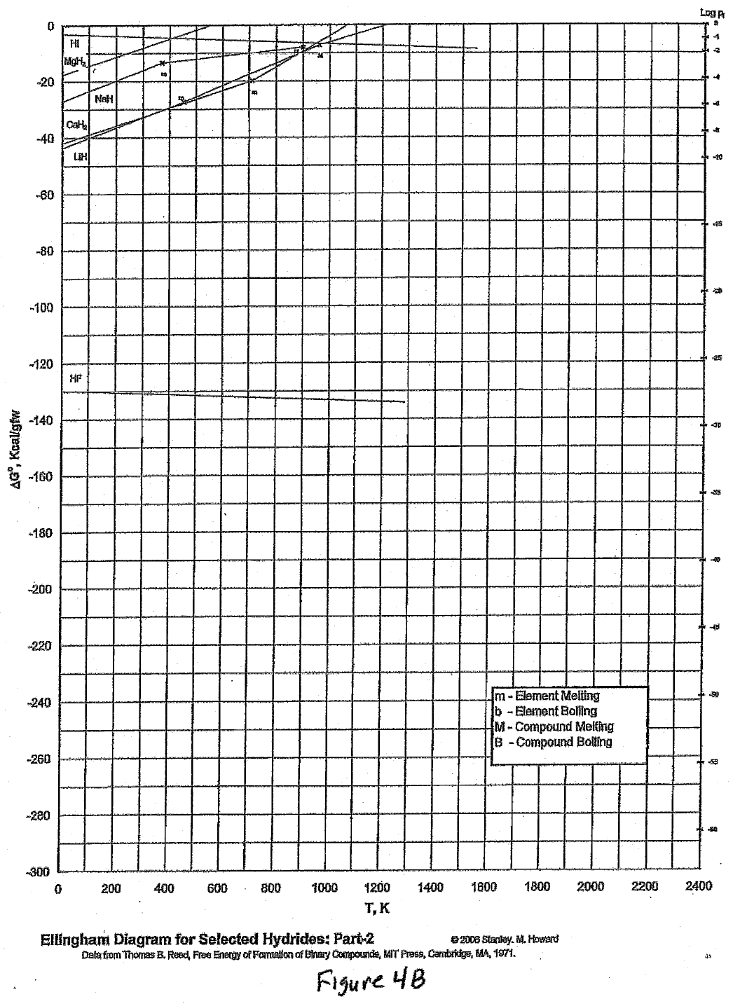

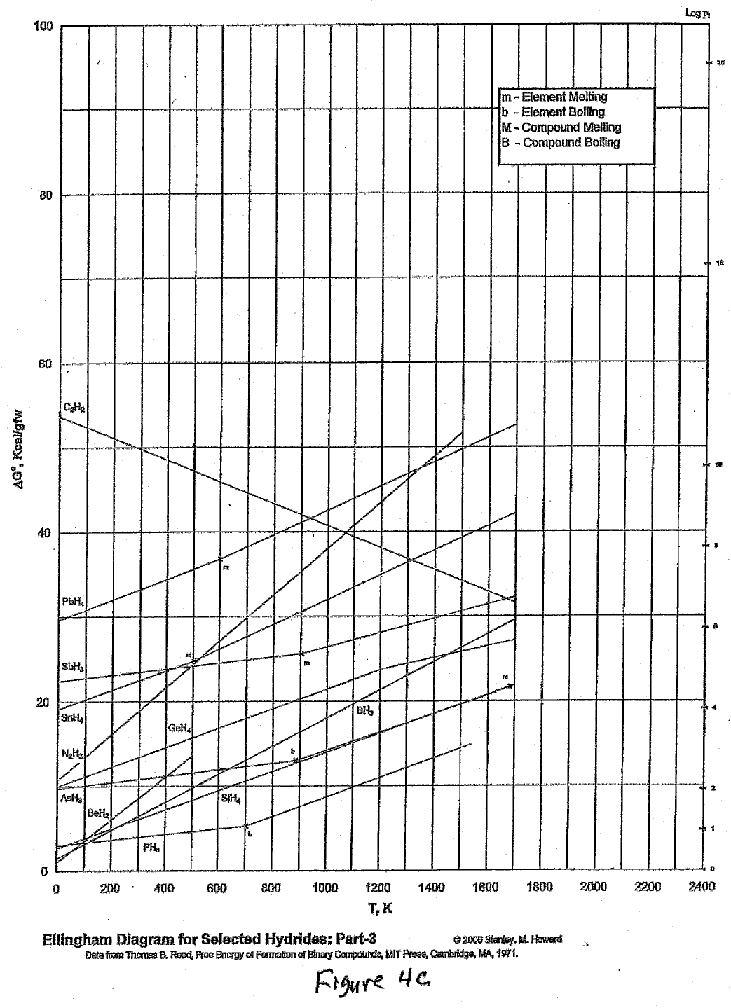

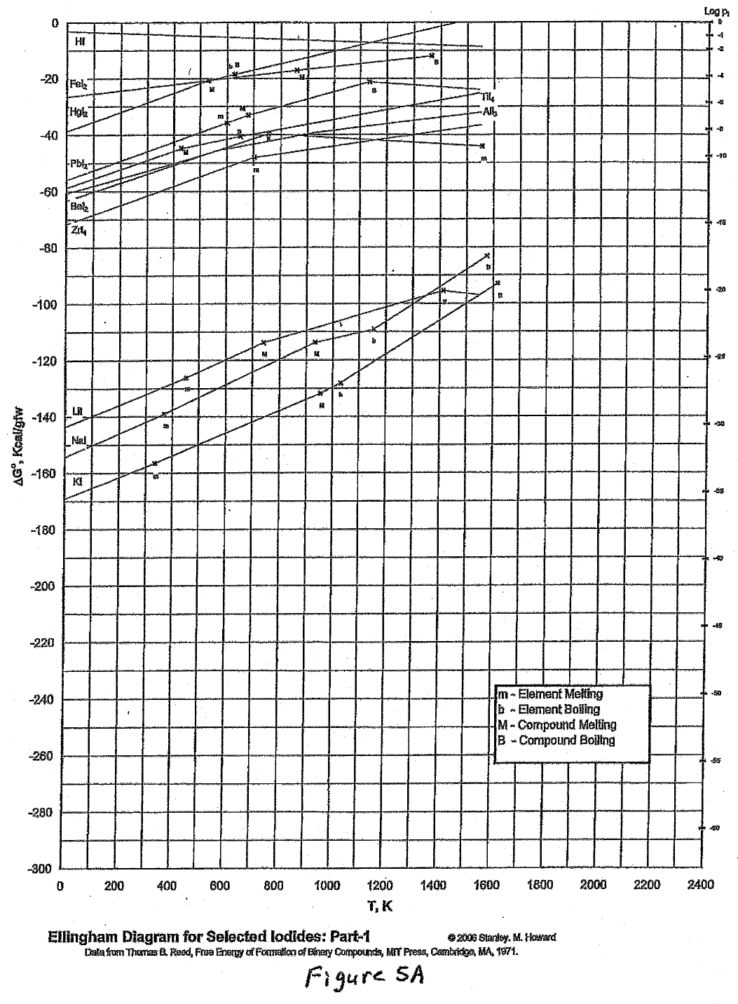

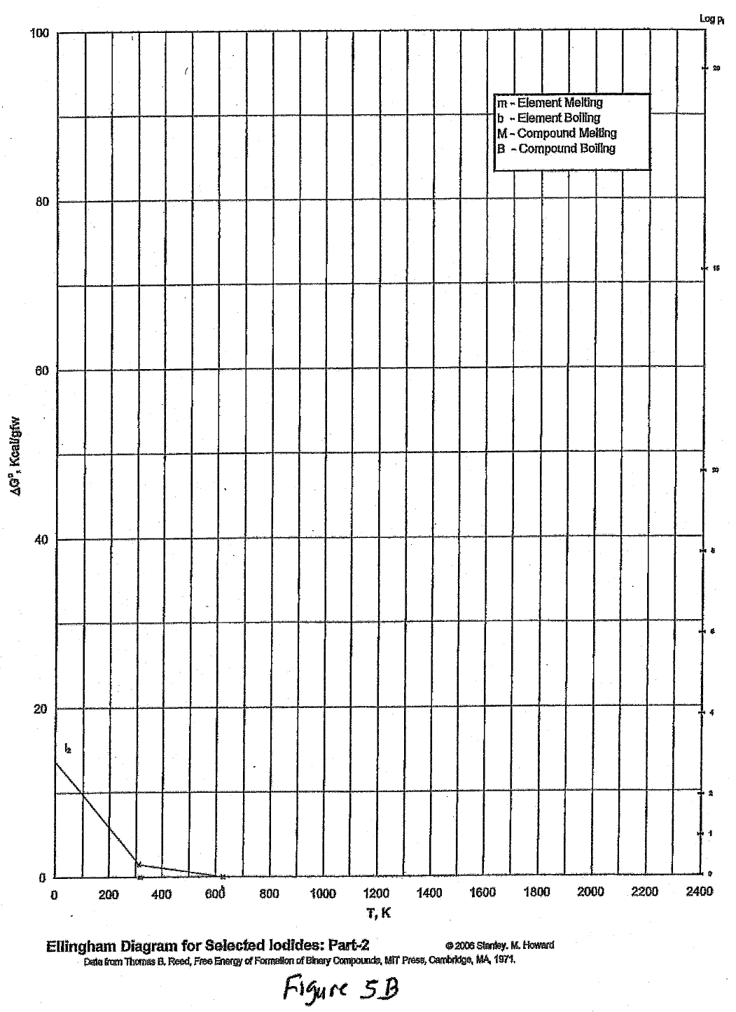

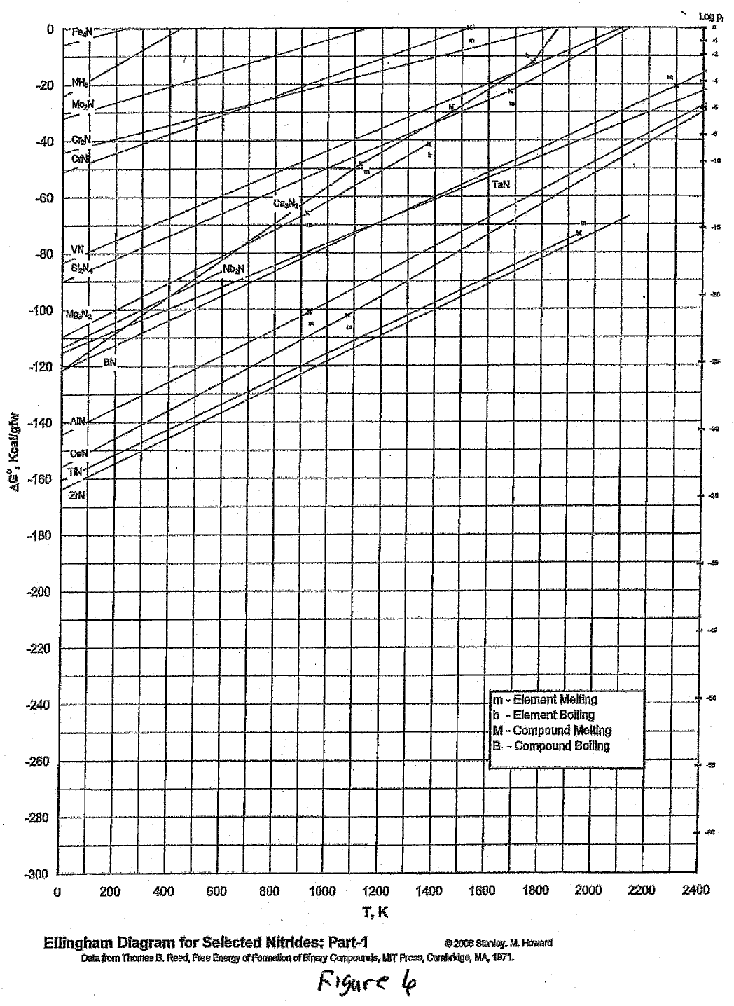

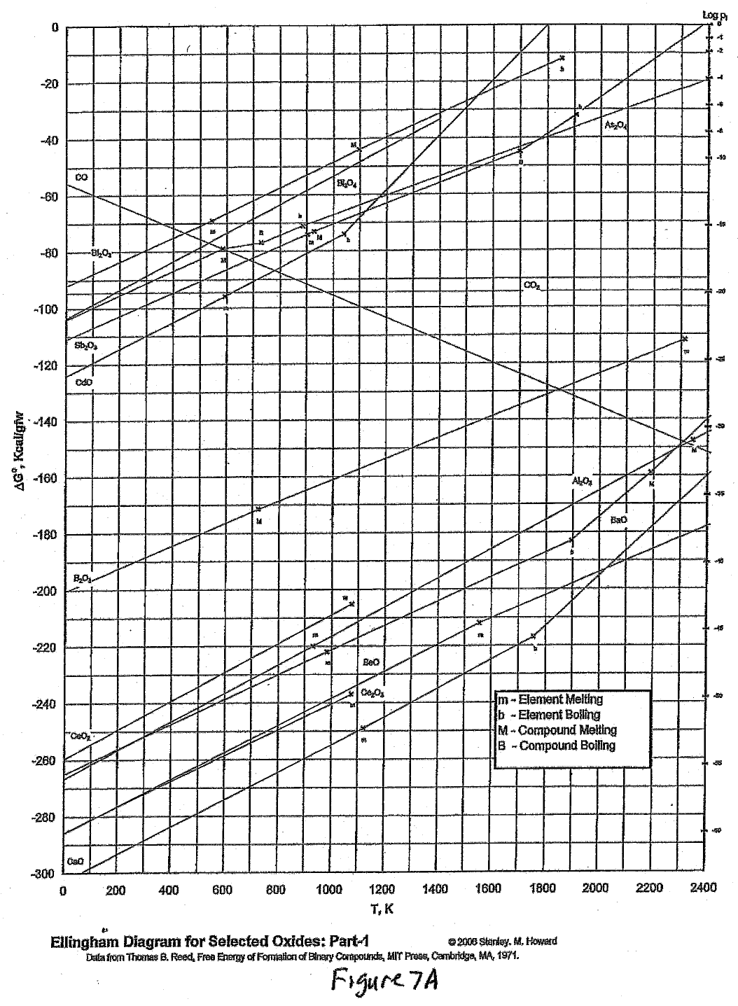

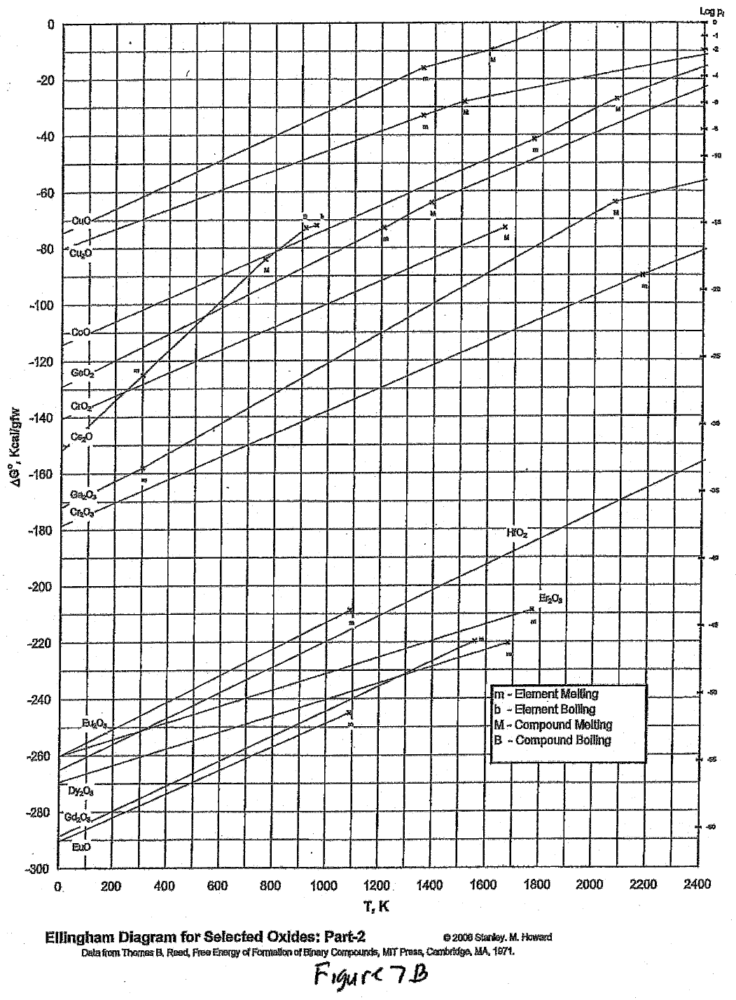

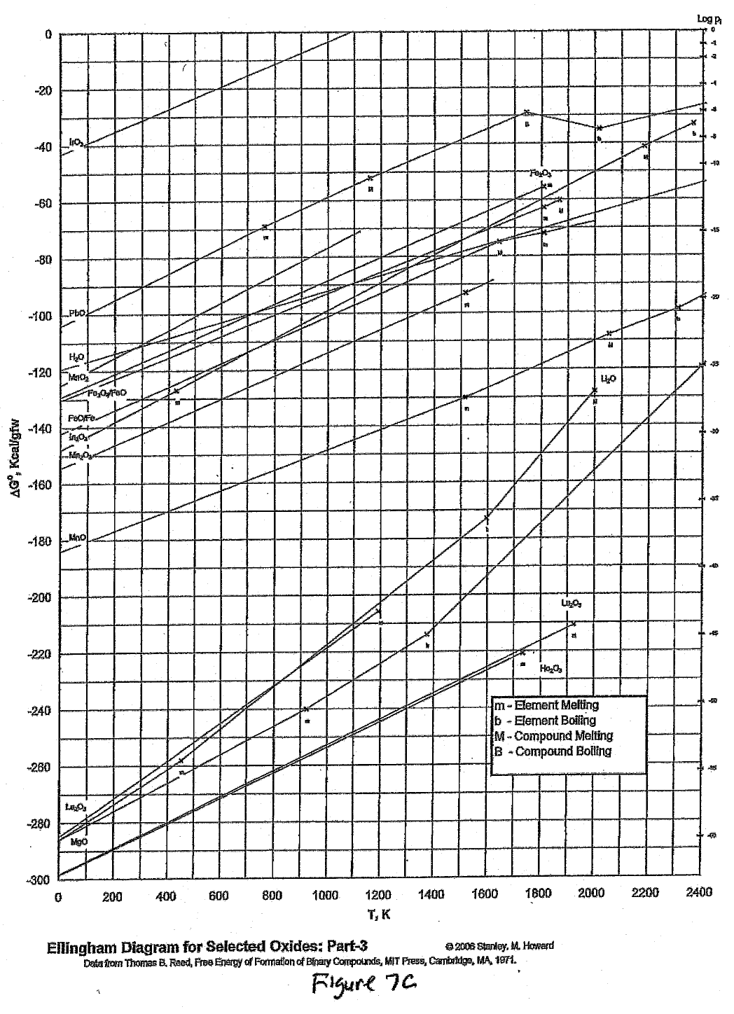

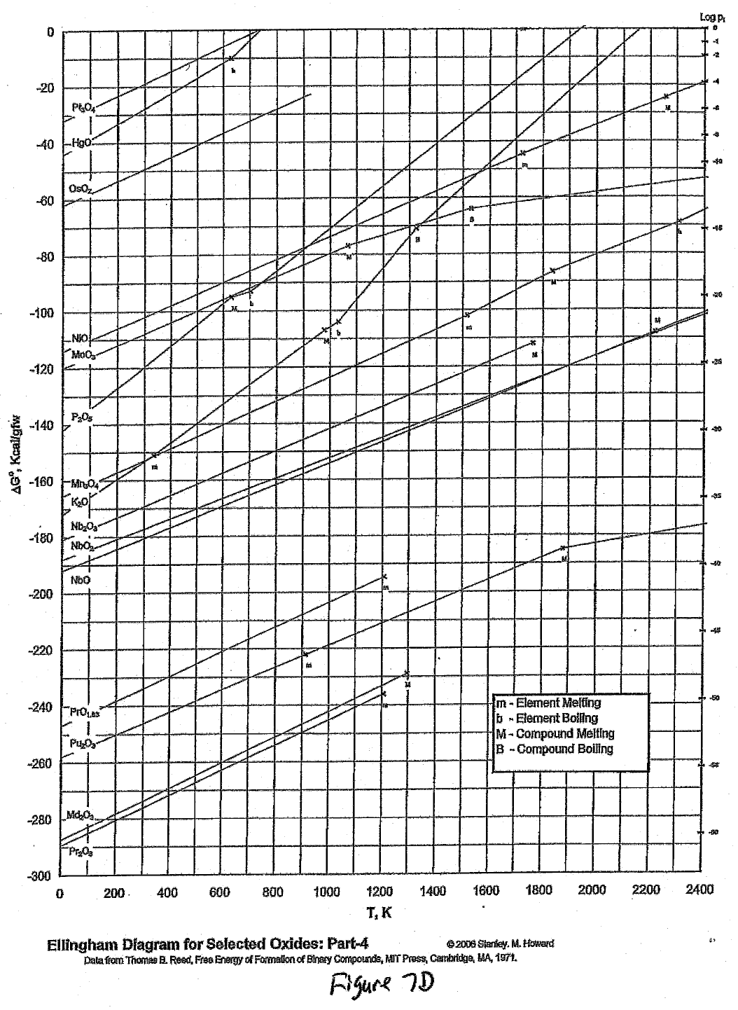

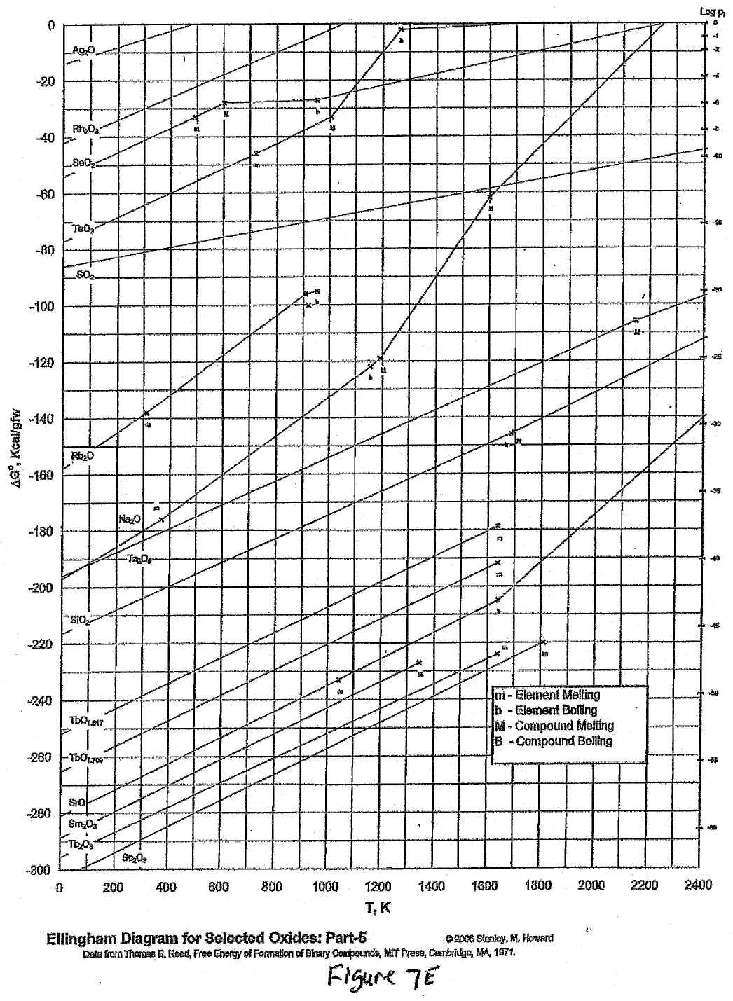

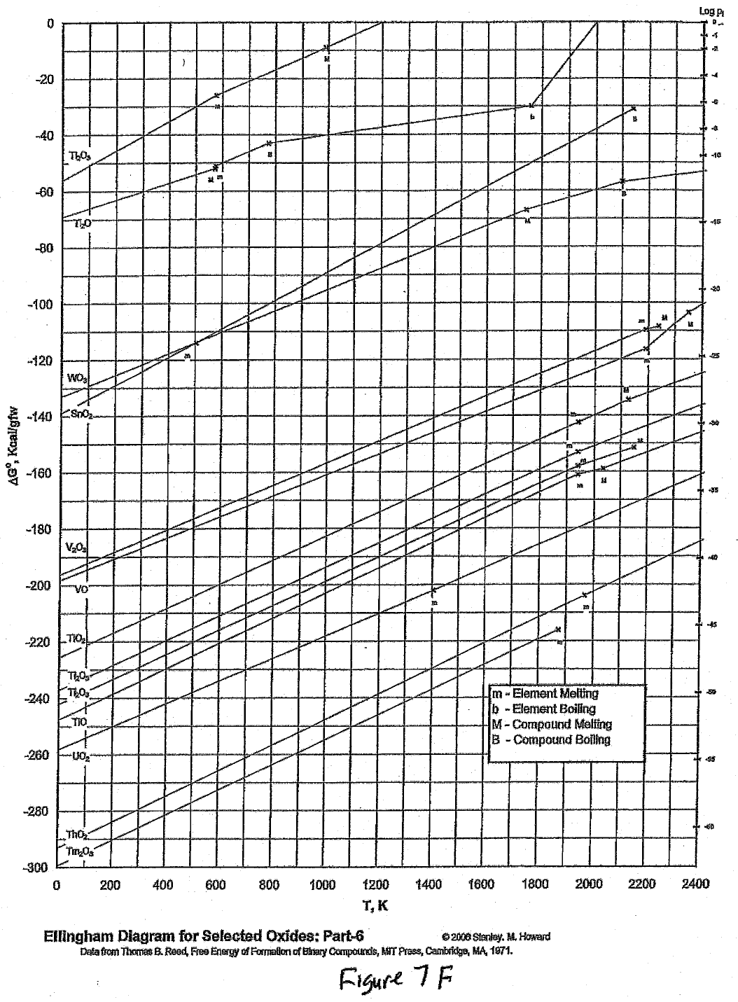

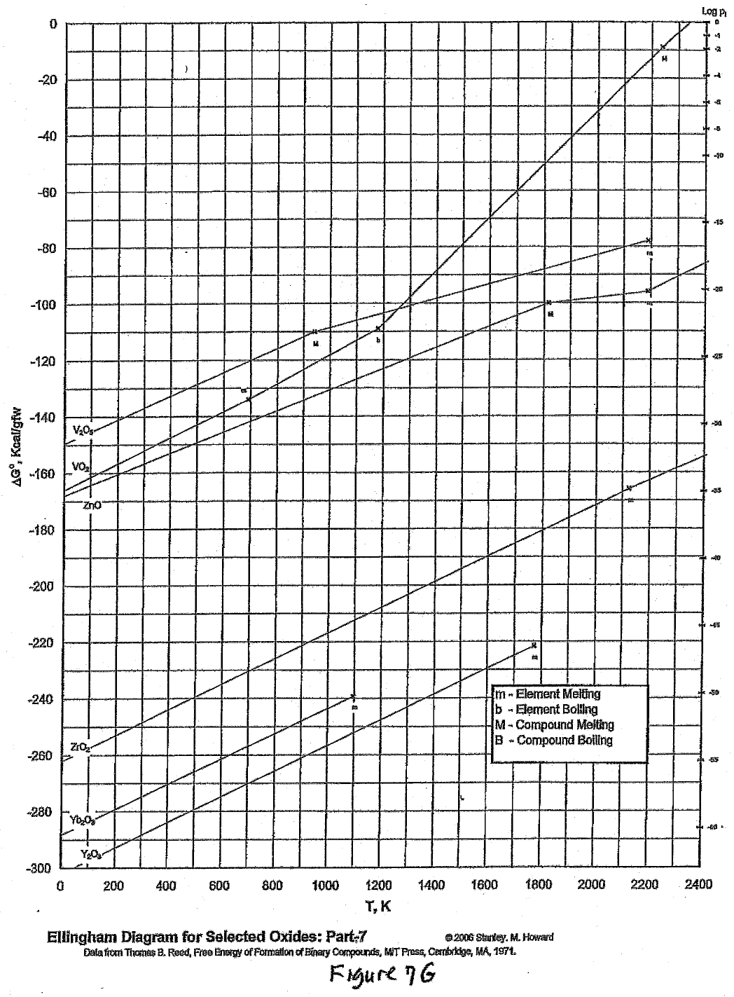

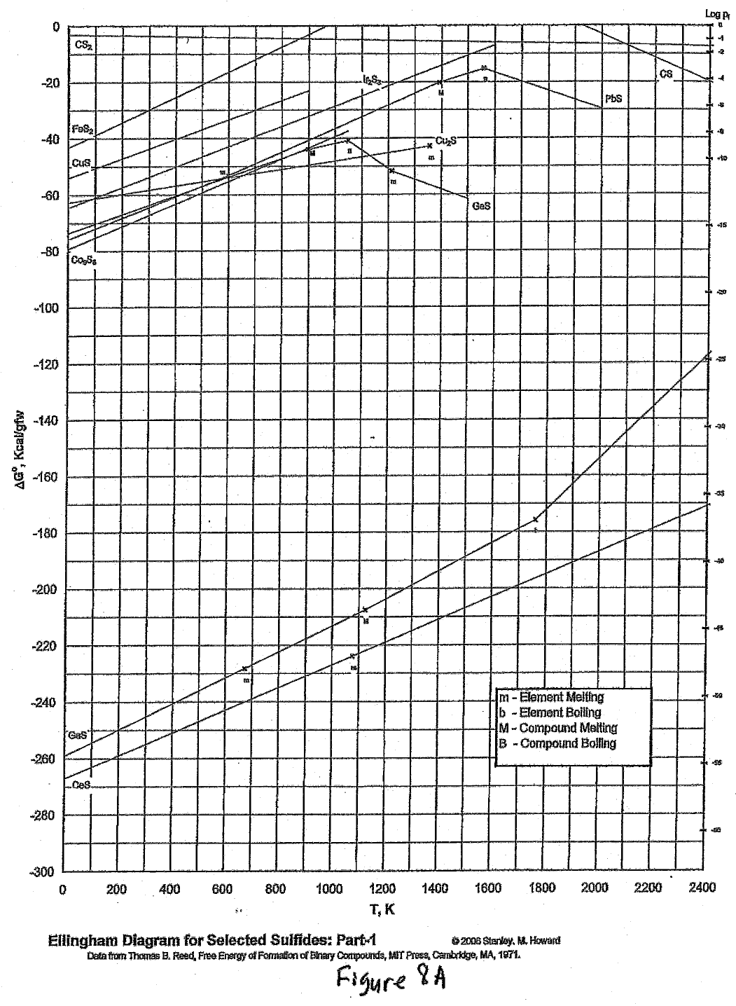

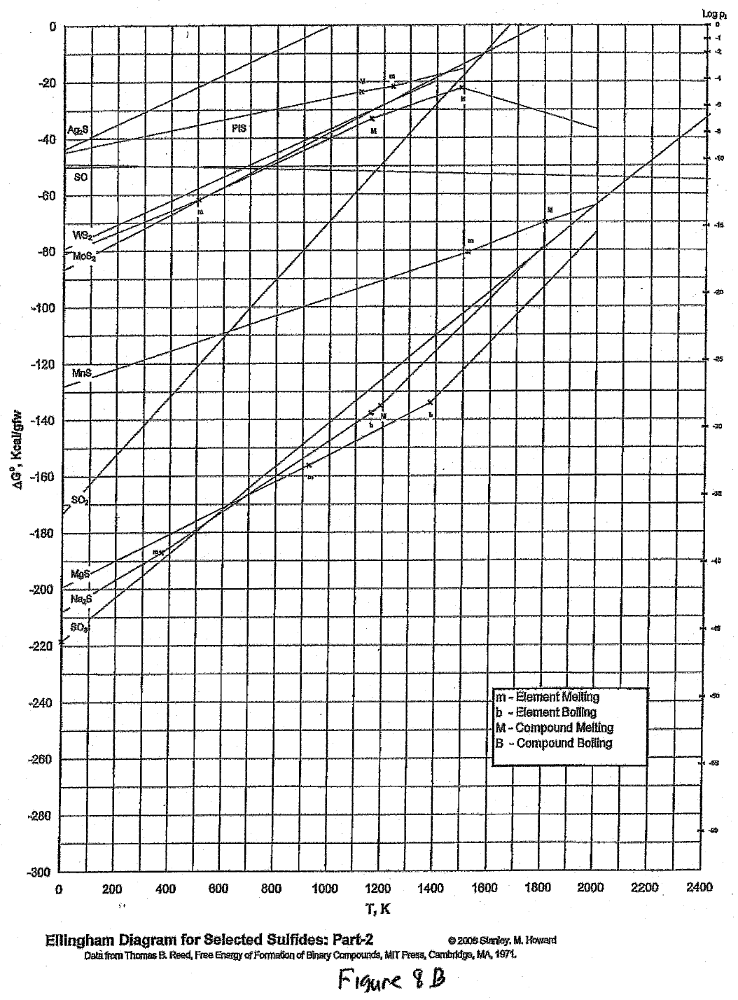

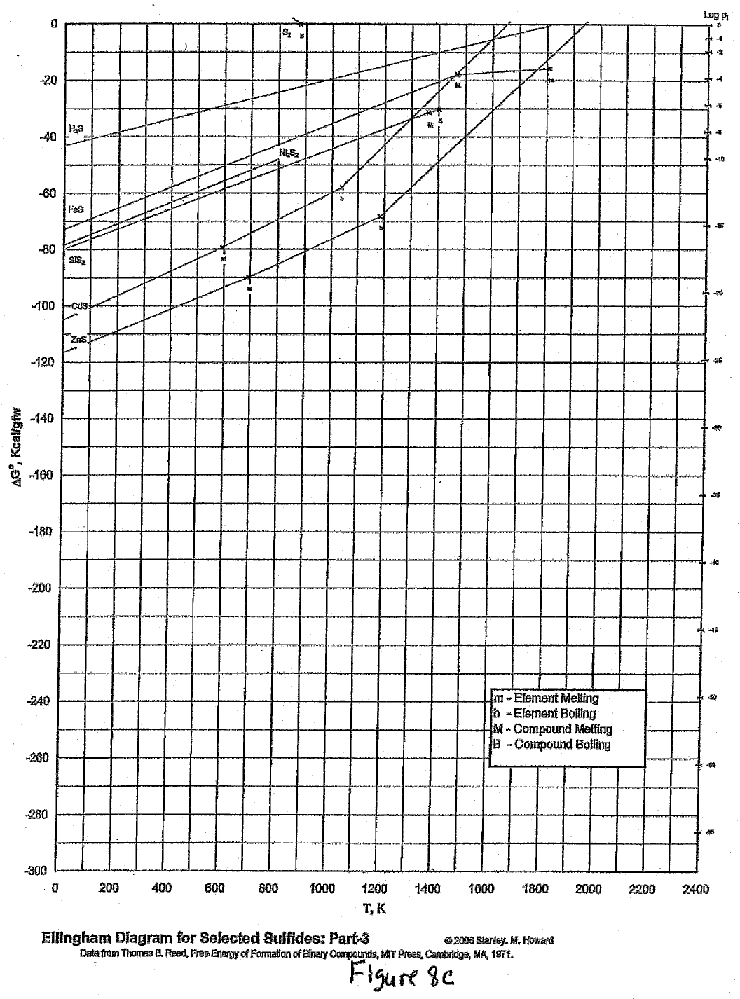

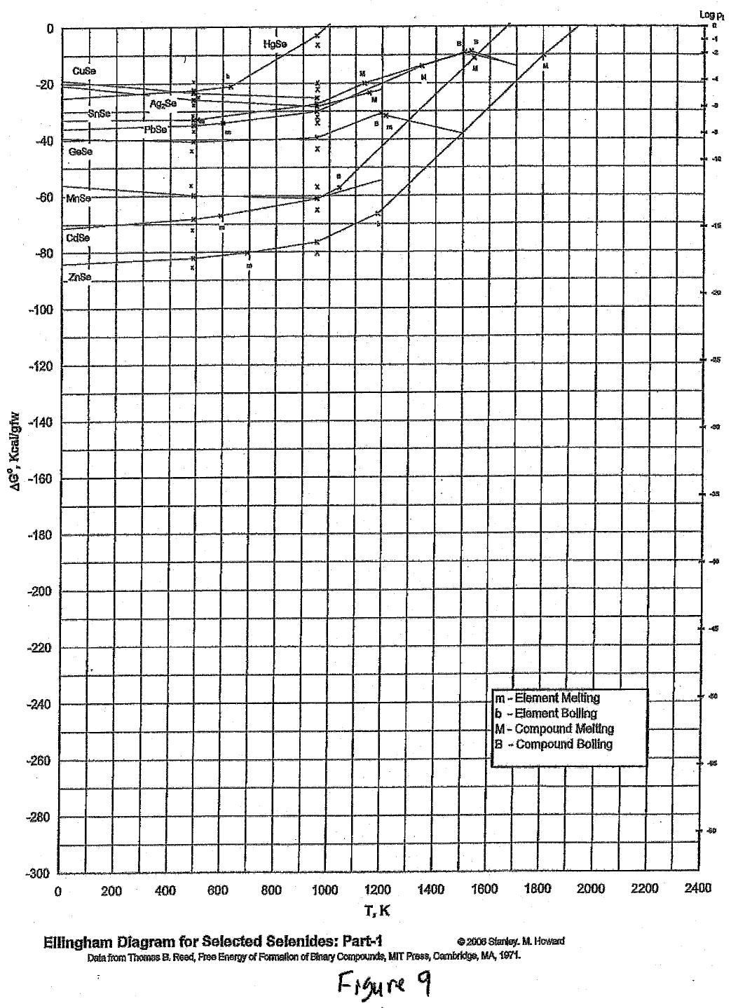

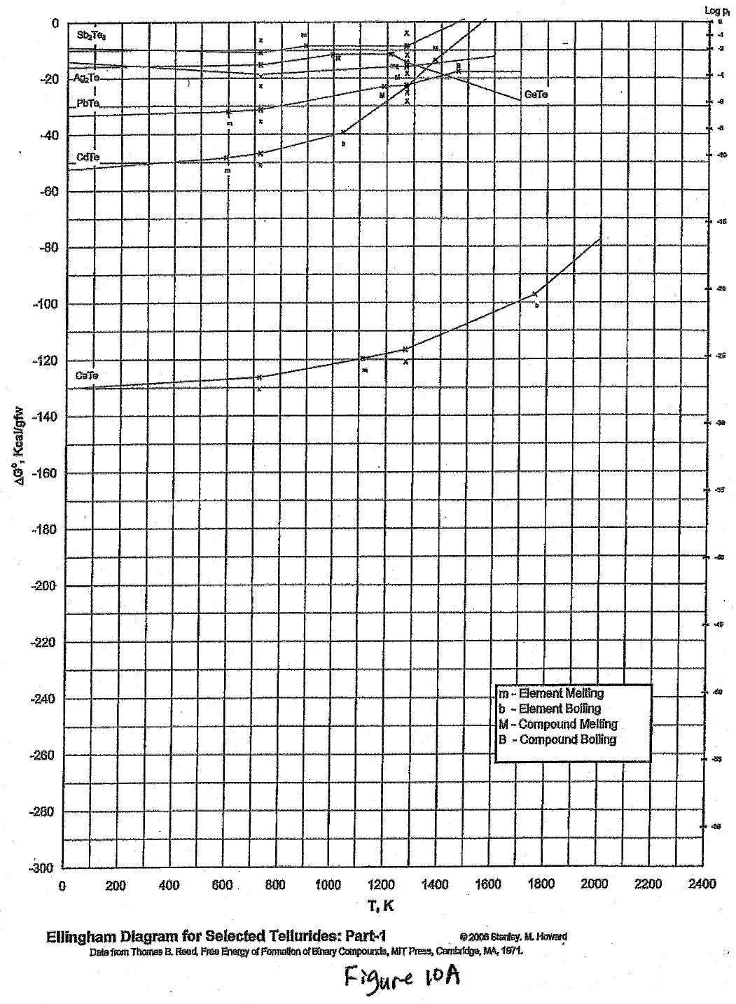

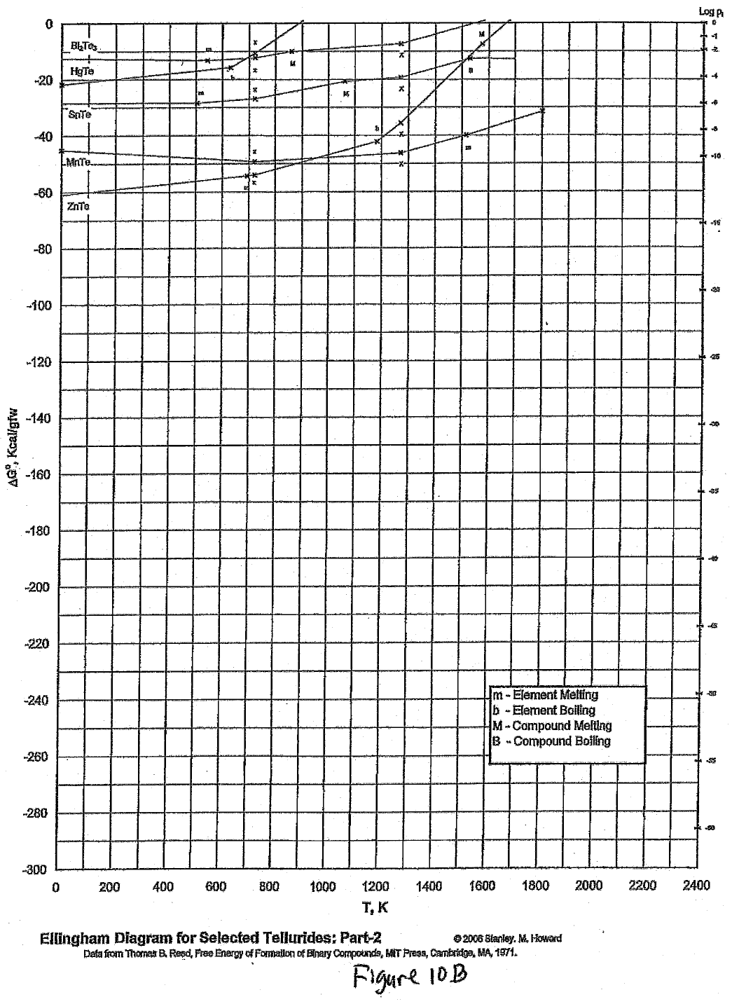

### DETAILED DESCRIPTION OF THE INVENTION

The present invention provides a composition comprising at least one aggregate and at least one phenolic resin, wherein said phenolic resin is pyrolyzed to result in the formation of a condensed ring glassy carbon, wherein said glassy carbon is a bonding matrix of the resulting composition. Preferably, the composition of the present invention includes wherein said aggregate is at least one selected from the group consisting of LiF, ZrF₄, MgF₂, KF, MnF₂, NaF, YF₃, BaF₂, CaF₂, BaO, Al₂O₃, SiO2, CaO, TiO₂, Ti₂O₅, Ti₂O₃, TiO, ZrO₂, Y₂O₃, MgO carbon compounds, graphite, SiC, B₄C (B₁₂C₃), WC, AlN, BN, a rare earth oxide, an alkali halide, and an alkaline halide, and combinations thereof. A preferred embodiment of this composition is wherein the aggregate is CaO plus Al₂O₃, and more preferably the aggregate is one of CaO-2Al₂O₃ (CaAlO₄), CaO—Al₂O₃, or CaO-6Al₂O₃, or combinations of one or more of CaO-2Al₂O₃ (CaAlO₄), CaO—Al₂O₃, and CaO-6Al₂O₃.

Another embodiment of this invention provides wherein the composition, as set forth herein, includes wherein said aggregate is a mixture of at least two or more of said aggregates.

Another embodiment of this invention provides a composition, as described herein, includes wherein the aggregate is an alkali halide that is at least one selected from the group consisting of LiCl, NaCl, and KCl, and corresponding fluoride (F), bromide (Br), or iodide (I) salts.

In another embodiment of this invention, the composition, as set forth herein, includes wherein the aggregate is an alkaline halide that is at least one selected from the group consisting of MgCl₂, CaCl₂, SrCl₂, and BaCl₂, and corresponding fluoride (F), bromide (Br) and iodide (I) salts.

Another embodiment of this invention provides wherein the composition, as set forth herein, includes wherein the aggregate is at least one selected from the group consisting of LiF, ZrF₄, MgF₂, KF, NaF, YF₃, BaF₂, and CaF₂.

In another embodiment of this invention, the composition, as set forth herein, includes wherein the resin is at least one selected from the group consisting of a novolac resin, a resol resin, or a combination of a mixture of a novolac resin and a resole resin. Preferably, the resin is a cross-linked phenolic resin. More preferably, the resin is a cross-linked and pyrolyzed phenolic resin.

In another embodiment of this invention, the composition, as set forth herein, includes wherein the aggregate is at least one selected from the group consisting of a calcium aluminate (CA), tabular alumina, bubble alumina, magnesium oxide, alumina oxide, calcium hexaaluminate, silicon carbide, sintered 45-70% alumina, fused mullite, fused magnesium aluminate spinel, and dead burned (DB) magnesium oxide, and combinations thereof.

In another embodiment of this invention, the composition, as set forth herein, includes wherein the aggregate is at least one selected from the group consisting of LiF, ZrF₄, MgF₂, KF, MnF₂, NaF, YF₃, BaF₂, CaF₂, BaO, Al₂O₃, SiO2, CaO, TiO₂, Ti₂O₅, Ti₂O₃, TiO, ZrO₂, Y₂O₃, MgO carbon compound, graphite, SiC, B₄C (B₁₂C₃), WC, AlN, BN, a rare earth oxide, an alkali halide, an alkaline halide, calcium aluminate (CA), tabular alumina, bubble alumina, magnesium oxide, alumina oxide, calcium hexa-aluminate, silicon carbide, sintered 45-70% alumina, fused mullite, fused magnesium aluminate spinel, and dead burned (DB) magnesium oxide, and combinations thereof.

In another embodiment of this invention, the composition, as set forth herein, includes wherein the glassy carbon is formed by heating said composition.

Other embodiments of this invention include wherein the composition, as set forth herein, include wherein the composition is in a form of a precast shape or a formed shape.

In another embodiment of this invention, the composition, as set forth herein, is a monolithic composition. The monolithic composition, may be for example, but not limited to, a shape of a wall or a floor of a structure.

In another embodiment of this invention, the composition, as described herein, has a rheology such that the composition may be rammed, cast, vibration cast, dry-vibrated, or sprayed.

In yet another embodiment of this invention, a method is provided for establishing a chemical and thermal barrier in a structure comprising lining a structure with a composition comprising at least one aggregate and at least one phenolic resin, wherein said phenolic resin is pyrolyzed to result in the formation of a condensed ring glassy carbon, wherein said glassy carbon is a bonding matrix of the resulting composition, wherein said composition forms a chemical and thermal barrier in said structure, wherein said structure is used in a process utilizing high temperature salts, said high temperature salts in a liquid and/or gas form, and wherein said process comprises a corrosive, acidic or basic process environment. The aggregates and resins used in this method are as described herein. Preferably, this method includes wherein the glassy carbon protects the aggregate from the salt and corrosive environment of the process.

Compatibility of an aggregate is first determined by evaluating the calculated/known Gibbs free energy of formation the salt materials being contained and comparing this to the calculated/known Gibbs free energy of formation of the aggregate and/or the specific chemical/mineral components which make up the aggregate. Specifically, we will choose an aggregate that is more stable (lower energy of formation, larger negative value of delta G) relative to that of the materials to be contained. Ellingham diagrams are used to relatively compare potential aggregate materials to each other based on criterion two as set forth herein and the desired process temperature range.

The physical requirements of the reaction or process vessel is next determined. For example, a process stream may be highly abrasive. In this case, we might consider a ‘more’ reactive aggregate if this aggregate provides necessary abrasion resistance. As with all things, a compromise of ideal properties is required when seeking an optimum solution. Therefore, cost of the aggregate is also an important aspect and so a less expensive but cost-effective aggregate may be chosen if the life time of the vessel is not important for the process. I.e. it may be more cost effective to replace a lining 5 times in 10 years compared to a more expensive lining that lasts the full 10 years.

The constant need for the applications, and hence the composition is to inhibit penetration and reaction by the molten and/or gas phase salt compositions and byproducts with the refractory/chemical barrier. Thereby, containing the process stream. In this case inhibit is synonymous with disallowing, preventing, slowing, resisting, tempering. This is accomplished by utilizing a phenolic based resin or resins, which form ‘glassy carbon’ when exposed to high temperatures. When the temperature exceeds the oxidation temperature of the glassy carbon, the composition should be in a reducing or inert atmosphere. Keep in mind that barriers may experience a temperature gradient through the 3-dimensional structure. Therefore, requirements for inert or reducing atmosphere will correspond to this gradient. The resin(s) are crosslinked via one or more standard methods which are familiar to those skilled in the science and study of polymers. This can be temperature, addition of chemical crosslinking agents, exposure to certain types of electrochemical radiation or portions of the electrochemical spectrum, etc.

The ‘ideal’ aggregate must meet certain conditions or criteria:
It must be solid and rigid at the desired processing temperature
It must be primarily comprised of a material that has a more stable Gibbs free energy of formation compared to that of the salt/salt mixture being contained and at the process temperature of interest (i.e. thermodynamically stable).
It must be primarily comprised of a material that has a chemical reaction coefficient which favors the aggregate material composition over that of potential reaction products with the salt/salt mixture at its/their process chemical concentration or range of concentrations and the process pressure and temperature.
It must provide the physical requirements necessary for the barrier system to perform as desired. These include but are not limited to; thermal conductivity, modulus of rupture, shear strength, compressive strength, bending strength, tensile strength, deformation under load, creep, and abrasion resistance.
If the barrier is to be used in areas with radiation, such as a nuclear reactor, it would be beneficial if the aggregate absorbed decay particles and/or neutron radiation.

Potentially suitable aggregate comprised primarily of a compound meeting the first criterion are as follows. These can be used as an aggregate individually or in any combination. The lowest melting point/thermal decomposition temperature will define the maximum suitable processing temperature. A lower melting point limit of 825° C. (1100° K) is defined as the desired minimum melting point. Such aggregates are 4LiF, ZrF₄, MgF₂, KF, MnF₂, NaF, YF₃, BaF₂, CaF₂, BaO, Al₂O₃, SiO2, CaO, TiO₂, Ti₂O₅, Ti₂O₃, TiO, ZrO₂, Y₂O₃, carbon compounds such as graphite, SiC, B₄C (B₁₂C₃), WC, AlN, BN. There are other compounds that meet the melting point criterion such as many of the rare earth oxides.

Suitable aggregates must also meet the second criterion. The most common salt/salt mixtures used in a variety of the applications discussed are the Alkali Halide salts and Alkaline Halide salts. For the chlorides, these are LiCl, NaCl, and KCl (alkali salts). And, MgCl₂, CaCl₂, SrCl₂, and BaCl₂ (alkaline salts) There are also the corresponding Fluoride (F), Bromide (Br) and Iodide (I) salts. Of these, the fluoride salts tend to be the most stable and as noted, the fluoride salts with the highest melting points are useful aggregates. Thus, using these salts as a benchmark and the specified low temperature of 325° C. (600° K), a ΔG of −185 kcal/gfw(mol) or less (larger negative value) is desired. Of the compounds listed previously, those that pass this criterion are: LiF, ZrF₄, MgF₂, KF, NaF, YF₃, BaF₂, CaF₂, BaO, Al₂O₃, SiO2, CaO, TiO₂, Ti₂O₅, Ti₂O₃, TiO, ZrO₂, Y₂O₃, carbon compounds such as graphite, SiC, B₄C (B₁₂C₃), WC, and the nitrides AlN, BN. The carbon compounds only meet this criterion in a non-oxidizing environment. SiC will meet the criterion in an oxidizing environment but only because of the formation of a protective SiO2 layer. This then is dictated by the relative SiO2 stability.

Suitable aggregates meeting the third criterion are based on potential reactions between the common salts listed above and the remaining compounds surviving the second criterion. Of the compounds listed previously those that pass this criterion are LiF, ZrF₄, MgF₂, KF, NaF, YF₃, BaF₂, CaF₂. (In the case of one fluoride used to contain another, the first two criteria should be used to make a choice: melting point and relative energetic stabilities. For example, an aggregate made of CaF₂ is suitable to contain liquid NaF but not the other way around.) If this situation arises, it is important to also consider this criterion in the case low melting eutectics are a possibility based on the various salt concentrations and temperature of interest.

Suitable aggregates meeting the fourth criterion are determined by the physical characteristics the aggregate will provide to the combined composite of the glassy-like carbon bond matrix plus the aggregate. The glassy-like carbon will not suffice as a barrier alone. It is susceptible to degradation due to thermal cycling. From a structural standpoint, it does not possess sufficient strengths to support significant loads from a tensile or compressive perspective. In order to supply these desirable physical characteristics, the composite utilizes an aggregate that enhances these desired characteristics compared to the glassy-like carbon alone. Strength attributes in a composite material are partially based on the strength of the individual components. Usually, the greatest strength is limited to weakest component. However, proper engineering of the composite can result in a combination of materials that have improved characteristics relative to the single components. This is the basis of engineered carbon structures where woven fibers in the form of sheets, are used in combination with a hardened binder to provide improved flexural strength in wing structures of aircraft, for example. In the same manner, an appropriate distribution of aggregate sizes within a composite will improve the strength characteristics as well as other physical properties, such as abrasion resistance, thermal conductivity, refractoriness under load, creep, etc. It is therefore necessary that the materials to be used as aggregates are available in a broad distribution of sizes. At least 80% of the total volume of aggregate should fall between 20μ (micron) and 25 mm in average diameter. Therefore, the aggregate should be available within these size parameters. The remaining compounds all have a defined melting point are able to be produced in a broad size distribution, even if that is not the case commercially, today. These materials would be created via a fusion or sintering process. Sized materials would be produced by typical crushing and sizing (screening) processes. Therefore potential, suitable aggregates can be made from LiF, ZrF₄, MgF₂, KF, NaF, YF₃, BaF₂, and CaF₂.

Suitable aggregate that would be potentially beneficial in radiation environments would be the denser materials of the above list. These would be ZrF4, BaF2 and YF3.

LiF, ZrF₄, MgF₂, KF, NaF, YF₃, BaF₂, and CaF₂ represent the ‘ideal’ and more preferred aggregate candidates. However, some of the aggregate candidates that were eliminated by the third criterion are not necessarily un-useful. They would not be considered ideal for long term exposure conditions due to likely reaction with the molten salts. These reactions would cause exposed aggregate (not protected by the glassy-like carbon bond at high temperatures or the crosslinked resins at low temperatures) to structurally and chemically decompose. In shorter term situations or in situations where the aggregate is encased in the resin or glassy-like carbon, the oxides, carbides and nitrides that were eliminated by the third criterion could be used as aggregate. However, even if the aggregate is protected by the glassy-like carbon bond material, certain processes such as flowing streams or pumping of fluids can cause abrasion on the surface of the barrier. The glassy carbon is not an abrasion resistant material and therefore, prolonged exposure to abrasion will expose aggregate, as such, long term chemical stability will be compromised.

It is important to keep in mind that an aggregate may be comprised of one or more of the pure compounds discussed herein, or mixtures thereof. Thus, the concentration of the weakest component may determine the overall potential of an aggregate for a particular application.

Preferred resin(s) for this application are those based on phenolic structures. These phenol formaldehyde resins a.k.a. phenolic resins are created by reaction of phenol or substituted phenol with formaldehyde. Two main types of commercial resins are available: Novolacs and Resoles. Novolacs have a formaldehyde to phenol molar ratio <1, while Resoles have a ratio >1. There are many, many different types of both Novolacs and Resoles. They can be solid or liquid and this is primarily based on molecular weight. Novolacs require a crosslinking agent (a.k.a. initiator) to set. This is typically Hexamethylenetetramine, sometimes referred to as hexamine. With the crosslinking compound and temperature above about 90° C., the Novolacs will begin to crosslink. Resoles are themosets and as such, they will crosslink with temperature and do not require the addition of a specific crosslinking agent. This typically occurs at temperature above 120° C. Setting temperatures as well as the rates of crosslinking reactions can be controlled by specific formulations of the resins and/or chemical additions to the resin compound. For our applications one or more resin may be used in any composition. In addition, we can use a mixture of solid and liquid resins as well as a mixture of Novolac resins and Resole resins (these will crosslink with each other). We may also add additional Hexamethylenetetramine to increase the rate or lower the temperature of the crosslinking reactions.

The general Novolac structure is set forth in Scheme 1:

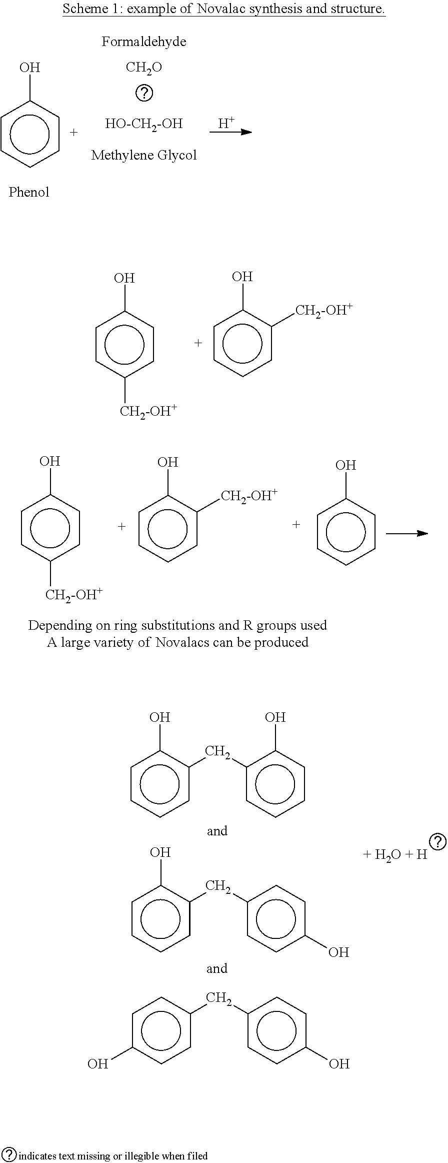

The general Resol structure is set forth in Scheme 2:

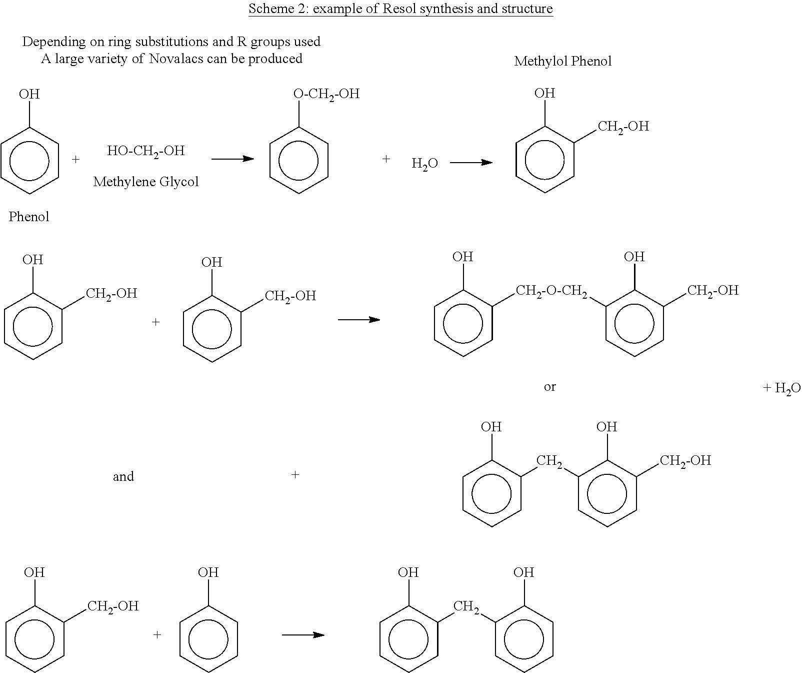

Cross-linking of the resins with temperature and an initiator is required to bond the constituents of the composition together and to provide the overall structure sufficient strength to act as a barrier. This is called a ‘thermoset’, i.e. setting with the application of heat. With additional heat under inert or reducing conditions the crosslinked resin structures will collapse into a tight ring structure and eventually a glassy carbon structure. The cross-linked resin structure will be resistant to salt attack. As the temperature increases the collapsed/condensed ring or glassy carbon structures that form will also resist attack and penetration of the various phases. This is important because of the aforementioned temperature gradient. Therefore, one expects a combination of crosslinked resin forms within the barrier.

Scheme 3 sets forth the structure of a common cross-linked phenolic resin. The commercial name of this example is ‘Bakelite’. The crosslinking increases the molecular weight of the polymer and eventually causes the resin to ‘set’ or become hard. Because of the nature of the phenols and the bonds holding them together, the polymer is very stable at high temperatures.

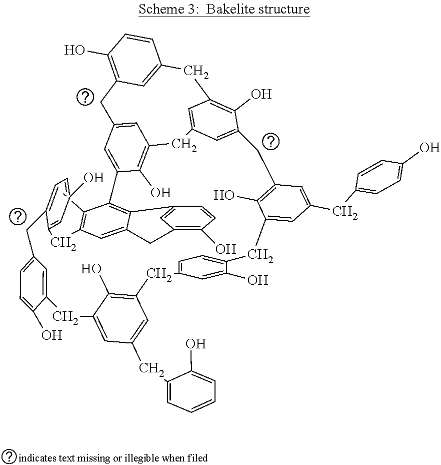

When the temperature is increased, lower boiling point compounds that are present in the resin mix or solution, such as unreacted phenols, glycols, formaldehydes, water etc. will be evolved or otherwise removed from the composite. Upon increasing the temperature where pyrolysis will occur (in an inert or reducing atmosphere) the structure may condense or collapse further. Below is an example of a crosslinked phenolic resin and the effect of temperature (in a nitrogen atmosphere) on the structure. The temperatures at which the ring condensation occur are controlled by the various (possible) linkages between the rings as well as the molecules substituted on the rings. Regardless of these, the end result is a collapsed ring structure similar to the representation shown after 500-800° C. in this example. The cross-linking groups between the rings are removed and the rings begin to bond directly to each other. This is the ‘glassy’ carbon structure. The collapsed section shown in this figure represents only a very small portion of what would be present in a pyrolyzed structure. Ideally, we would prefer this form of the resin bonding the aggregate (forming the barrier) at the operating temperatures of the specific process of interest. However, keep in mind the temperature gradient which will exist in the barrier. As a result of this, various forms of the crosslinked resin will exist across this temperature gradient. A uniform form of the resin can only be achieved if the entire barrier is exposed to a uniform temperature, this is not impossible but would be unnecessarily difficult and hence expensive. This could be considered if it is necessary to use preformed shapes such as bricks. As long as the portion of the barrier which is in contact with the molten salts is pyrolyzed (a.k.a. Hot Face), this will suffice to provide penetration and reaction resistance.

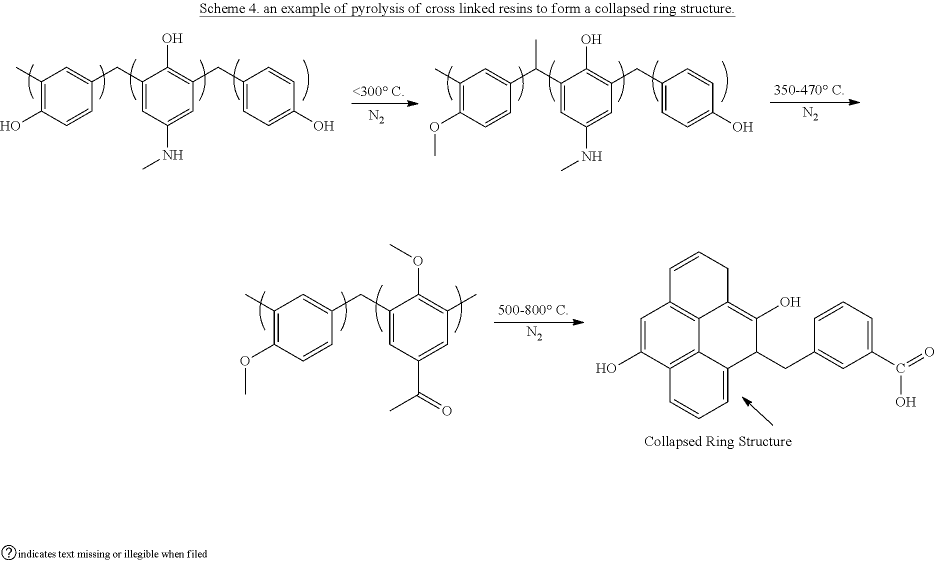

This is the inert/resistant bond matrix which ties the aggregate together. The choice of aggregate provides additional physical and chemical property requirements for a barrier designed for a specific process of interest.

### Detailed Compositional Strategy

The following examples demonstrate a detailed compositional matrix and some physical properties of the resulting solid body. Phenolic resins for this work were obtained from Hexion, Inc. Hexion supplies several different types of phenolic resins. In the following examples we use both dry and liquid resins. These are RD-2414, RD-2424A, RD-2475, RD-763B, RL-964B and RL-744C. RD indicates a dry resin and RL indicates a liquid resin. RD-2414, RD-763B and RD-2475 are Novolacs. RL-964B and RL-744C is a liquid resole resin. The choice of the resin or resins are based on needs for specific applications as has been discussed previously. The choice of resin or resins (in mixed systems) is also determined by the placement needs such as vibration casting, ramming, shotcreting, etc. It is also determined by how quick or slow a set is required and what temperature ranges the set will occur. Hexamethylenetetramine (‘Hexa’), also supplied by Hexion is the nitrogen bearing crosslinking agent used to initiate the initial polymerization reaction. Some resins already contain the Hexa. If it is required and not present, it must be added to the mix. Many different types of phenolic resins can be used, including many not listed here, the ultimate requirement of the resin is that it will form ‘glassy’ like carbon (a collapsed ring structure) as a result of a pyrolysis process (Scheme 4).

The aggregate materials were obtained from several sources. These include Tabular Alumina from Zili USA, 100 Ali Street, Pittsburgh Pa. and Almatis Inc., 501 West Park Rd, Leetsdale, Pa. Calcium Flouride (CaF2) from Seaforth Mineral & Ore Company, Inc., 3690 Orange Place, Sute 495, Cleveland Ohio Calcium Aluminate (Gorkal—AG 70A) from Gorka Cement Sp.z. o. o, ul. Lipcowa 58, 32-540 Trzebinia, Poland and U.S. Electrofused Minerals, Inc., 600 Steel Streeet, Aliquippa, Pa. Hibonite or Calcium Hexaaluminate (Bonite) Almatis Inc, 501 West Park Rd, Leetsdale Pa. Silicon Carbide (SiC) Electro Abrasives, 701 Willet Road, Buffalo, N.Y. Sintered 45-70% Alumina (Mulcoa 47, 60 and 70) Imerys Refractory Minerals, 100 Mansell Colurt East, Ste 615, Roswell, Ga. Fused Mullite U.S. Electrofused Minerals, Inc. 600 Steel St, Aliquippa, Pa. Fused Magnesium aluminate Spinel (MUB) U.S. Electrofused Minerals, Inc. 600 Steel St, Aliquippa, Pa. Dead Burned Magnesium Oxide (MagChem P98) Martin Marietta Magnesia Specialties, LLC. 8140 Corporate Drive, Ste 220, Baltimore, Md. Filler material used in the finer screed sizes to increase density and or fill in porosity between the aggregates are Calcined Alumina (AC44B6) and reactive aluminas (PBR and PFR) from Alto, Avenue Victor Hugo, 13240 Gardanne, France, Zili USA LLC, 100 Ali Street, Pittsburgh, Pa. and Almatis Inc, 501 West Park Rd, Leetsdale, Pa. Carbon Black (Black Pearls 280) from Cabot Corporation, 157 Concord Rd, Billerica, Mass. Amorphous and Flake Graphite Superior Graphites, 10 S. Riverside Plaze, Ste 1470, Chicago Ill.

As used herein, “m” means mesh, and “mm” means millimeter. Thus, for example, “3/6 m” means a particle size diameter range of from about 3 to 6 mesh. For example, “−325 m” means a particle diameter size smaller than 325 mesh.

### Example A

| Tabular Alumina 3/6 m | 10-35% (wt) |
|---|---|
| Tabular Alumina 6/14 m | 20-50% (wt) |
| Tabular Alumina 14/28 m | 3-15% (wt) |
| Tabular Alumina 28/48 m | 5-20% (wt) |
| Tabular Alumina −48 m | 2-15% (wt) |
| Tabular Alumina −325 m | 0-10% (wt) |
| A-2 Calcined Alumina | 0-10% (wt) |
| A-3000FL Reactive Alumina | 0-15% (wt) |
| RG4000 Reactive Alumina | 0-15% (wt) |
| RD-2414 Resin | 0-10% (wt) |
| Water (plus addition) | 0-15% (wt) |
| Surfactant (plus addition) | 0-1% (wt) |
| RL 964B Resin (plus addition) | 3-17% (wt) |
| Density (pcf) | 120-165 |
| Open Porosity | <10% |
| CCS (psi) | 2000-8500 |

Example A consisted of 10 subsamples of varying composition using tabular alumina (TA) as the base aggregate and fine alumina as the fillers. Both a liquid and solid resin were used. These samples proved the ranges of aggregate (specific for tabular alumina but used as a guideline for other aggregates (surface texture, porosity and wettability with the resins, viscosity of the resins used dictate actual ranges for specific aggregate/fines and resin systems. Example A and subsets provide an approximate starting point when moving to specific systems.

In all examples which follow the pyrolyzed phenolic resins act as a barrier to the salt or salt mixture as described previously. The aggregates also provide resistance to reaction with the salt or salts based on their relative thermodynamic stability. However, as previously stated, the choice of aggregate might be driven by another need such as abrasion resistance, strength, or even cost. Therefore, the eventual aggregate chosen may not be the ‘optimum’ choice if based solely on reactivity with the salt or salt mixture. As long as the resin system is employed according to the art described herein. The overall composition will retain a level of non-reactivity that will provide sufficient protection to the composition in contact with the salt or salt mixture for the process of interest in which the salt or salt mixture is being utilized. Properties were determined after curing each sample to >350° F.

### Example B

| TA 3/6 m | 5-15% (wt) |
|---|---|
| TA 6/14 m | 25-35% (wt) |
| TA 14/28 m | 5-15% (wt) |
| TA 28/48 m | 5-15% (wt) |
| TA −48 m | 0-10% (wt) |
| TA −325 m | 0-10% (wt) |
| AC-17RG Alumina | 0-15% (wt) |
| LISAL 07RAL Alumina | 0-15% (wt) |
| RD-2414 Resin | 5-15% (wt) |
| Density (pcf) | 139+/−7 |
| Open Porosity | <10% |
| CCS (psi) | 5900-6800 |

Example B based aggregate systems would be chosen for higher temperature applications where abrasion resistance is important.

### Example C

| Mulcoa 60 ⅜ m | 25-35% (wt) |
|---|---|
| Mulcoa 60 8/20 m | 10-20% (wt) |
| Mulcoa 60 −20 m | 5-15% (wt) |
| Mulcoa 60 −48 m | 5-15% (wt) |
| Mulcoa 60 −200 m | 5-15% (wt) |
| AC-17RG Alumina | 0-15% (wt) |
| LISAL 07RAL Alumina | 0-15% (wt) |
| RD-2414 Resin | 5-15% (wt) |
| Density (pcf) | 113+/−5 |
| Open Porosity | <10% |
| CCS (psi) | 5500-6500 |

Example C demonstrates an aggregate system that represents a more ‘economical’ approach.

### Example D

| CaF₂ 4/10 m | 25-35% (wt) |
|---|---|
| CaF₂ 10/30 m | 10-20% (wt) |
| CaF₂ 30/60 m | 5-15% (wt) |
| CaF₂ −60 m | 5-15% (wt) |
| CaF₂ −325 m | 5-15% (wt) |
| AC-17RG Alumina | 0-15% (wt) |
| LISAL 07RAL Alumina | 0-15% (wt) |
| RD-2414 Resin | 5-15% (wt) |
| Density (pcf) | 116+/−5 |
| Open Porosity | <10% |
| CCS (psi) | 5500-6500 |

Example D provides for a system that would be very non-reactive with a variety of Halide salts, particularly Chlorides, Bromides and Iodides.

### Example E

| Hibonite 3/6 mm | 20-30% (wt) |
|---|---|
| Hibonite ⅓ mm | 10-20% (wt) |
| Hibonite 0.5/1 mm | 5-15% (wt) |
| Hibonite 0/0.5 mm | 5-15% (wt) |
| Hibonite −45 μ | 0-10% (wt) |
| AC-17RG Alumina | 0-15% (wt) |
| LISAL 07RAL Alumina | 0-15% (wt) |
| RD-2414 Resin | 5-15% (wt) |
| Density (pcf) | 124+/−6 |
| Open Porosity | <10% |
| CCS (psi) | 6000-6900 |

Example E would be useful in alkaline and alkaline earth salts, where strength would also be required.

### Example F

| Fused CA 0.5″/35 m | 0-7% (wt) |
|---|---|
| Fused CA 3.5/7 m | 20-35% (wt) |
| Fused CA 7/18 m | 10-20% (wt) |
| Fused CA 18/35 m | 5-15% (wt) |
| Fused CA 35/60 m | 5-15% (wt) |
| Fused CA −60 m | 0-10% (wt) |
| Fused CA −325 m | 5-10% (wt) |
| AC-17RG Alumina | 0-15% (wt) |
| LISAL 07RAL Alumina | 0-15% (wt) |
| RD-2414 Resin | 5-15% (wt) |
| Density (pcf) | 116+/−5 |
| Open Porosity | <10% |
| CCS (psi) | 5500-6500 |

Example F would be useful in alkaline and alkaline earth salts, where great strength is not required.

### Example G

| Sinter CA 6/12 mm | 0-10% (wt) |
|---|---|
| Sinter CA 2/6 mm | 25-35% (wt) |
| Sinter CA 0.5/2 mm | 15-25% (wt) |
| Sinter CA 0/0.5 mm | 10-20% (wt) |
| Sinter CA −45 μ | 5-15% (wt) |
| AC-17RG Alumina | 0-15% (wt) |
| LISAL 07RAL Alumina | 0-15% (wt) |
| RD-2414 Resin | 5-15% (wt) |
| Density (pcf) | 105+/−5 |
| Open Porosity | <10% |
| CCS (psi) | 4000-5000 |

Example G is a system that provides some protection against alkaline and alkaline earth salts but is also insulating.

### Example H

| Bubble Alumina −4 m | 40-55% (wt) |
|---|---|
| Bubble Alumina −48 m | 10-20% (wt) |
| Bubble Alumina −325 m | 5-15% (wt) |
| AC-17RG Alumina | 0-15% (wt) |
| LISAL 07RAL Alumina | 0-15% (wt) |
| RD-2414 Resin | 5-15% (wt) |
| Density (pcf) | 70+/−5 |
| Open Porosity | <10% |

CCS (psi) 1000-1900

Example H is a system that provides an insulating system that is also relatively strong and abrasion resistant.

### Example I

| DB MgO P98 −⅛″ | 25-40% (wt) |
|---|---|
| DB MgO P98 −30 m | 10-20% (wt) |
| DB MgO P98 (pulv) | 20-35% (wt) |
| AC-17RG Alumina | 0-15% (wt) |
| LISAL 07RAL Alumina | 0-15% (wt) |
| RD-2414 Resin | 5-15% (wt) |
| Density (pcf) | 123 +/− 6 |
| Open Porosity | <10% |
| CCS (psi) | 4000-4900 |

Example I would be useful in systems that are basic such as certain alkali and alkaline earth salts. Substitution of MgO/Al₂O₃Spinels for the MgO would allow for a similar resistance but improved strength and abrasion resistance.

### Example J

| Hibonite 3/6 mm | 20-30% (wt) |
|---|---|
| Hibonite 1/3 mm | 10-20% (wt) |
| Hibonite 0.5/1 mm | 5-15% (wt) |
| Hibonite 0/0.5 mm | 5-15% (wt) |
| Hibonite −45 μ | 0-10% (wt) |
| Fused MgO/Al2O3 Spinel MUB 3/6 mm | 20-30% (wt) |
| Fused MgO/Al2O3 Spinel MUB 1/3 mm | 10-20% (wt) |
| Fused MgO/Al2O3 Spinel MUB 0.5/1 mm | 5-15% (wt) |
| Fused MgO/Al2O3 Spinel MUB 0/0.5 mm | 5-15% (wt) |
| Fused MgO/Al2O3 MUB Spinel −45 μ | 5-15% (wt) |
| AC-17RG Alumina | 0-15% (wt) |
| LISAL 07RAL Alumina | 0-15% (wt) |
| RD-2414 Resin | 5-15% (wt) |
| Density (pcf) | 128 +/− 6 |
| Open Porosity | <10% |
| CCS (psi) | 5500-7200 |

Example J is an example of a mixture of two aggregate systems, Hibonite and Fused MgO/Al₂O₃Spinel, which encompasses the positive aspects of both aggregates. This example is not intended to limit the scope of “aggregate combinations,” but is only one example of various combinations of aggregates that can be used in this invention.

Examples B-J utilize a dry powder resin and these compositions would be ideal for a dry vibratable installation or forming process. Examples B-J can also be vibration-cast, pump-cast, dry gunnited, and wet shotcreted by using the appropriate surfactants/dispersants and water contents know by those skill in the art of monolithic refractory research and development.

### Example K

| TA 3/6 m | 10-20% (wt) |
|---|---|
| TA 6/14 m | 25-35% (wt) |
| TA 14/28 m | 5-15% (wt) |
| TA 28/48 m | 5-15% (wt) |
| TA −48 m | 0-10% (wt) |
| TA −325 m | 0-10% (wt) |
| AC-17RG Alumina | 0-15% (wt) |
| LISAL 07RAL Alumina | 0-15% (wt) |
| RD-2414 Resin | 0-10% (wt) |
| Black Pearls 280 carbon | 0-10% (wt) |
| Surfactant | 0.01-.25% (wt) |
| Water | 8-12% (wt) |
| Density (pcf) | 155-165 |
| Open Porosity | <10% |
| CCS (psi) | 1800-2900 |

Example K is a composition suitable for vibration casting. This uses a surfactant which allows for control of the water's adhesion/cohesion properties. The surfactant can be any number of similar materials in the market. Examples are Marasperse, Melflux, Castament, STPP, Darvan, to name a few. The amount of surfactant required depends on the specific surfactant employed and its interaction with the remainder of the composition. Ideally, the surfactant utilized will reduce the amount of water required to achieve a particular flow of material under vibration and is used to characterize a vibration cast material and/or a self-flowing material (flows with gravity only).

### Examples L, M, and N

| TA 3/6 m | 10-20% (wt) |
|---|---|
| TA 6/14 m | 25-35% (wt) |
| TA 14/28 m | 5-15% (wt) |
| TA 28/48 m | 5-15% (wt) |
| TA −48 m | 0-10% (wt) |
| TA −325 m | 0-10% (wt) |
| AC-17RG Alumina | 0-15% (wt) |
| LISAL 07RAL Alumina | 0-15% (wt) |
| RD-2424A Resin (example L) | 5-15% (wt) |
| RD-2475 Resin (example M) | 5-15% (wt) |
| RD-763B Resin (example N) | 5-15% (wt) |
| Density (pcf) | 135-150 |
| Open Porosity | <10% |
| CCS (psi) | 4000-6000 |

Examples L-N are suitable as dry vibratible compositions, wherein each of example L, example M, and example N, each employed a different dry, powdered resin.

### Example O

| Hibonite 1/3 mm | 15-25 (wt) |
|---|---|
| Hibonite 0.5/1 mm | 20-30% (wt) |
| Hibonite 0/0.5 mm | 12-22% (wt) |
| Hibonite −45 μ | 10-20% (wt) |
| Hibonite −20 μ | 12-22% (wt) |
| AC-17RG Alumina | 0-15% (wt) |
| LISAL 07RAL Alumina | 0-15% (wt) |
| Amorphous Graphite | 0-10% (wt) |
| RD-2424A Resin | 1-7% (wt) |
| RL-2395 Resin | 3-8% (wt) |
| Density (pcf) | 124 +/− 6 |
| Open Porosity | <10% |
| CCS (psi) | 8000-9000 |

Example O is a mix utilizing both a liquid and powdered resin. This mix is suitable for pressing shapes, such as typical 9″×3.5″ or 9″×4″ brick.

### Example P

| CaF₂ 4/10 m | 25-35% (wt) |
|---|---|
| CaF₂ 10/30 m | 10-20% (wt) |
| CaF₂ 30/60 m | 5-15% (wt) |
| CaF₂ −60 m | 5-15% (wt) |
| CaF₂ −325 m | 5-15% (wt) |
| AC-17RG Alumina | 0-15% (wt) |
| LISAL 07RAL Alumina | 0-15% (wt) |
| RD-2414 Resin | 0-10% (wt) |
| RL-964B Resin | 5-15% (wt) |
| Density (pcf) | 115 +/− 5 |
| Open Porosity | <10% |
| CCS (psi) | 5000-6000 |

### Example Q

| CaF₂ 4/10 m | 25-35% (wt) |
|---|---|
| CaF₂ 10/30 m | 10-20% (wt) |
| CaF₂ 30/60 m | 5-15% (wt) |
| CaF₂ −60 m | 5-15% (wt) |
| CaF₂ −325 m | 5-15% (wt) |
| AC-17RG Alumina | 0-15% (wt) |
| LISAL 07RAL Alumina | 0-15% (wt) |
| RD-2475 Resin | 0-10% (wt) |
| RL-964B Resin | 5-15% (wt) |
| Density (pcf) | 112 +/− 5 |
| Open Porosity | <10% |
| CCS (psi) | 4000-5000 |

### Example R

| CaF₂ 4/10 m | 25-35% (wt) |
|---|---|
| CaF₂ 10/30 m | 10-20% (wt) |
| CaF₂ 30/60 m | 5-15% (wt) |
| CaF₂ −60 m | 5-15% (wt) |
| CaF₂ −325 m | 5-15% (wt) |
| AC-17RG Alumina | 0-15% (wt) |
| LISAL 07RAL Alumina | 0-15% (wt) |
| RD-763B Resin | 0-10% (wt) |
| RL-964B Resin | 5-15% (wt) |
| Density (pcf) | 112 +/− 5 |
| Open Porosity | <10% |
| CCS (psi) | 4000-5000 |

### Example S

| CaF₂ 4/10 m | 25-35% (wt) |
|---|---|
| CaF₂ 10/30 m | 10-20% (wt) |
| CaF₂ 30/60 m | 5-15% (wt) |
| CaF₂ −60 m | 5-15% (wt) |
| CaF₂ −325 m | 5-15% (wt) |
| AC-17RG Alumina | 0-15% (wt) |
| LISAL 07RAL Alumina | 0-15% (wt) |
| RD-2414 Resin | 0-10% (wt) |
| RL-744C Resin | 5-15% (wt) |
| Density (pcf) | 122 +/− 5 |
| Open Porosity | <10% |
| CCS (psi) | 3900-4800 |

### Example T

| CaF₂ 4/10 m | 25-35% (wt) |
|---|---|
| CaF₂ 10/30 m | 10-20% (wt) |
| CaF₂ 30/60 m | 5-15% (wt) |
| CaF₂ −60 m | 5-15% (wt) |
| CaF₂ −325 m | 5-15% (wt) |
| AC-17RG Alumina | 0-15% (wt) |
| LISAL 07RAL Alumina | 0-15% (wt) |
| RD-2475 Resin | 0-10% (wt) |
| RL-744C Resin | 5-15% (wt) |
| Density (pcf) | 119 +/− 5 |
| Open Porosity | <10% |
| CCS (psi) | 3400-5300 |

### Example U

| CaF₂ 4/10 m | 25-35% (wt) |
|---|---|
| CaF₂ 10/30 m | 10-20% (wt) |
| CaF₂ 30/60 m | 5-15% (wt) |
| CaF₂ −60 m | 5-15% (wt) |
| CaF₂ −325 m | 5-15% (wt) |
| AC-17RG Alumina | 0-15% (wt) |
| LISAL 07RAL Alumina | 0-15% (wt) |
| RD-763B Resin | 0-10% (wt) |
| RL-744C Resin | 5-15% (wt) |
| Density (pcf) | 121 +/− 5 |
| Open Porosity | <10% |
| CCS (psi) | 3700-5100 |

Examples P-U represent compositions that use a mixture of liquid and dry resins. These compositions would be suitable as ramming mixes or plastics. If the liquid resin is in the higher range, they would be suitable as castables.

### Example V

| CaF₂ 4/10 m | 25-35% (wt) |
|---|---|
| CaF₂ 10/30 m | 10-20% (wt) |
| CaF₂ 30/60 m | 5-15% (wt) |
| CaF₂ −60 m | 5-15% (wt) |
| CaF₂ −325 m | 5-15% (wt) |
| AC-17RG Alumina | 10-20% (wt) |
| LISAL 07RAL Alumina | 5-15% (wt) |
| RL-964B Resin | 5-15% (wt) |
| Density (pcf) | 113 +/− 5 |
| Open Porosity | <10% |
| CCS (psi) | 3000-3900 |

### Example W

| CaF₂ 4/10 m | 25-35% (wt) |
|---|---|
| CaF₂ 10/30 m | 10-20% (wt) |
| CaF₂ 30/60 m | 5-15% (wt) |
| CaF₂ −60 m | 5-15% (wt) |
| CaF₂ −325 m | 5-15% (wt) |
| AC-17RG Alumina | 10-20% (wt) |
| LISAL 07RAL Alumina | 5-15% (wt) |
| RL-744C Resin | 5-15% (wt) |
| Density (pcf) | 118 +/− 5 |
| Open Porosity | <10% |
| CCS (psi) | 4000-4800 |

Examples V-W are based on all liquid resin binder systems. These would be appropriate as a castable on the higher range of resin concentration and as a ramming mix or plastic on the lower range.

In the following example we will assume a process which requires maintaining a mixture of NaCl and KCl salts in the temperature range of 825-1000° C. Based on the electronegativity of Fluoride salts relative to Chloride salts skilled in the art can surmise that CaF₂ would be thermodynamically stable in contact with NaCl and KCl. Referring to the Ellingham diagrams for these compounds it can be seen that CaF₂ appears to be the more stable of the compounds within this temperature range. However, the relative stability will be controlled by the ratio of salt concentration. Furthermore, the melting point of CaF2 is higher than the maximum temperature range of the process of interest. If we assume the barrier designed must also act as a supporting structure, then the aggregate chosen must provide sufficient strength to act in this manner. CaF2 provides sufficient strength when incorporated into a suitable particle packing (distribution) scheme. The choice of CaF2 as the aggregate is therefore a preferred embodiment for this case.

Next, we can assume that the preferred method of installation would be to vibrate a dry mixture of the composition into place within the forms defining the barrier structure. Consequently, in this case, a dry resin only system would be the preferred embodiment. We will choose RD-2414 as the resin. In order to provide sufficient flow under vibration (in order to densify the composition within the forms) it is necessary to add material which has a fine particle size. In this case, we will use two types of alumina. AC-17RG has a particle size of approximately 2.5μ and the LISAL 07RAL has a particle size of approximately 0.6μ. The alumina will react with the Na and K in the salt mixture. Therefore, we want to use a sufficient volume of resin to protect these materials by separating them from contact with the salt bath by creating the glassy like carbon structure around the alumina. Some reaction will still occur and in this case it is desired. The Na(K)—Al₂O₃ material is a larger molecule relative to Al₂O₃. This is an expansive reaction which closes down internal porosity and places the final structure under compression. This improves the strength of the structure, much like prestressed concreted.

### Example X

| CaF₂ 4/10 m | 30% (wt) |
|---|---|
| CaF₂ 10/30 m | 15% (wt) |
| CaF₂ 30/60 m | 10% (wt) |
| CaF₂ −60 m | 10% (wt) |
| CaF₂ −325 m | 10% (wt) |
| AC-17RG Alumina | 10% (wt) |
| LISAL 07RAL Alumina | 5% (wt) |
| RD-2414 Resin | 10% (wt) |
| Density (pcf) | 115 |
| Open Porosity | <3% |
| CCS (psi) | 6000 +/− 300 |

Example X represents a preferred embodiment of a resin composition for use at up to 1000° C. that will act as a barrier for a mixture of molten NaCl and KCl and will also act as an engineered structural support. The particle size distribution chosen results in a material that will flow under vibration to meet placement needs. Furthermore, it provides enough closed porosity to result in a lower density material, 115 pcf after curing. This will provide sufficient thermal insulating capability so that the overall thickness of the structure can be maintained to a reasonable cross section. Increasing the density will likely result in increased thermal conductivity which may require the use of insulating materials as a backup to the barrier structure in order to provide sufficient insulating capability.

In another example we required a pressed shape that will operate in a temperature range of 900-1200° C. In this case the salt bath is comprised of a mixture of CaCl₂ and CaCO₃. The use of halides is not desired since an ionic exchange may occur between the barrier and the salt bath, rendering the salt bath as ‘contaminated’. This eliminates CaF₂ as a possibility. In this case we can examine either Hibonite or Tabular Alumina as potential aggregate choices. At these temperatures the CaCO₃ will decompose to CaO but will remain in equilibrium with the CO₂. Those skilled in the art might suppose that the Hibonite, which is CaO-6Al₂O₃ represents a less reactive choice of aggregate at these temperatures. In this case, we will use a mix of a dry and liquid resin in order to provide a consistency which allows the composition to be pressed into a shape. The particle size distribution also plays a role in this. Graphite is added to act as a release agent from the press mold. A preferred embodiment of the desired composition is as follows:

### Example Y

| Hibonite 1/3 mm | 21 (wt) |
|---|---|
| Hibonite 0.5/1 mm | 25% (wt) |
| Hibonite 0/0.5 mm | 18% (wt) |
| Hibonite −45 μ | 15% (wt) |
| Hibonite −20 μ | 17% (wt) |
| Amorphous Graphite (plus addition) | 4% (wt) |
| RD-2424A Resin (plus addition) | 2% (wt) |
| RL-2395 Resin (plus addition) | 5% (wt) |
| Press Density (pcf) | 169 +/− 4 |
| Density (pcf) | 165 +/− 3 |
| Open Porosity | <8% |
| CCS (psi) | 8390 +\− 250 |

The appropriate mass of material is loaded into a hydraulic press. 15,000 psi was applied to provide a press density of approximately 169 pcf. In this case, the preferred embodiment represents a pressed wedge shape which is used to create a cylindrical holding vessel or barrier.

These examples are not intended to limit the scope of the present invention as described herein. Several different types of phenolic resins (Resoles and Novolacs, as well as physical states of these resins as solids, liquids, and blends of these) can be used to create these compositions. Initially the resins help define the means by which the compositions will be installed. They act as an initial thermal set binder, holding the aggregate together. Eventually and importantly, they are converted into a glassy like carbon structure through pyrolysis. The glassy like carbon acts as a barrier to the salt bath and binds the aggregate. The preferred choice of aggregate is defined by its relative thermodynamic stability in contact with the salt or salt mixture. However, when economy is desired, reactive aggregate can be used (such as Mulcoa 60) and the resin content can be increased to provide chemical protection. Other physical characteristics are used to determine an appropriate aggregate in order to provide strength, insulating capability, abrasion resistance, temperature resistance, and non-wettability, for example. The distribution of the particle size helps determine desired physical and installation characteristics along with the choice of resin(s). A method to choose the preferred embodiment of the aggregate is provided. Because there are many potential salts and salt mixtures there are a corresponding number of potential solutions to a barrier. A specifically designed barrier will be the preferred embodiment of a specific salt or salt mixture. In all cases, and representing the minimum yet most important preferred embodiment, the formation of a glassy like carbon within the composition, provides for the necessary barrier to contain the salt(s). The preferred source of the glassy like carbon are the phenolic resins. In the preferred embodiment the amount of open porosity in the pyrolyzed composition will be <10%, while the ideal open porosity would be 0%, it is difficult and often impractical to achieve. These examples are for purposes of illustration and it will be evident to those persons skilled in the art that numerous variations and details of the instant invention may be made without departing from the instant invention as set forth herein.

We claim:

1. A composition comprising at least one aggregate and at least one phenolic resin, wherein said phenolic resin is pyrolyzed to result in the formation of a condensed ring glassy carbon, wherein said glassy carbon is a bonding matrix of the resulting composition.

2. The composition of claim 1 wherein said aggregate is at least one selected from the group consisting of LiF, ZrF₄, MgF₂, KF, MnF₂, NaF, YF₃, BaF₂, CaF₂, BaO, Al₂O₃, SiO2, CaO, TiO₂, Ti₂O₅, Ti₂O₃, TiO, ZrO₂, Y₂O₃, MgO carbon compounds, graphite, SiC, B₄C (B₁₂C₃), WC, AlN, BN, a rare earth oxide, an alkali halide, and an alkaline halide, and combinations thereof.

3. The composition of claim 2 including wherein said aggregate is CaO plus Al₂O₃.

4. The composition of claim 2 including wherein said aggregate is one of CaO-2Al₂O₃ (CaAlO₄), CaO—Al₂O₃, or CaO-6Al₂O₃, or combinations of one or more of CaO-2Al₂O₃ (CaAlO₄), CaO—Al₂O₃, and CaO-6Al₂O₃.

5. The composition of claim 2 wherein said aggregate is a mixture of at least two or more of said aggregates.

6. The composition of claim 2 wherein said alkali halide is at least one selected from the group consisting of LiCl, NaCl, and KCl, and corresponding fluoride (F), bromide (Br), or iodide (I) salts.

7. The composition of claim 2 wherein said alkaline halide is at least one selected from the group consisting of MgCl₂, CaCl₂, SrCl₂, and BaCl₂, and corresponding fluoride (F), bromide (Br) and iodide (I) salts.

8. The composition of claim 2 wherein said aggregate is at least one selected from the group consisting of LiF, ZrF₄, MgF₂, KF, NaF, YF₃, BaF₂, and CaF₂.

9. The composition of claim 1 wherein said resin is at least one selected from the group consisting of a novolac resin, a resol resin, or a combination of a mixture of a novolac resin and a resole resin.

10. The composition of claim 1 wherein said resin is a cross-linked phenolic resin.

11. The composition of claim 1 wherein said resin is a cross-linked and pyrolyzed phenolic resin.

12. The composition of claim 1 wherein said aggregate is at least one selected from the group consisting of a calcium aluminate (CA), tabular alumina, bubble alumina, magnesium oxide, alumina oxide, calcium hexaaluminate, silicon carbide, sintered 45-70% alumina, fused mullite, fused magnesium aluminate spinel, and dead burned (DB) magnesium oxide, and combinations thereof.

13. The composition of claim 1 wherein said aggregate is at least one selected from the group consisting of LiF, ZrF₄, MgF₂, KF, MnF₂, NaF, YF₃, BaF₂, CaF₂, BaO, Al₂O₃, SiO2, CaO, TiO₂, Ti₂O₅, Ti₂O₃, TiO, ZrO₂, Y₂O₃, MgO carbon compound, graphite, SiC, B₄C (B₁₂C₃), WC, AlN, BN, a rare earth oxide, an alkali halide, an alkaline halide, calcium aluminate (CA), tabular alumina, bubble alumina, magnesium oxide, alumina oxide, calcium hexa-aluminate, silicon carbide, sintered 45-70% alumina, fused mullite, fused magnesium aluminate spinel, and dead burned (DB) magnesium oxide, and combinations thereof.

14. The composition of claims 1-13 wherein said glassy carbon is formed by heating said composition.

15. The composition of claims 1-14 that is in a form of a precast shape or a formed shape.

16. The composition of claims 1-14 that is a monolithic composition.

17. The composition of claim 16 wherein said monolithic composition is in the shape of a wall or a floor of a structure.

18. The composition of claim 14 having a rheology such that said composition may be rammed, cast, vibration cast, dry-vibrated, or sprayed.

19. A method of establishing a chemical and thermal barrier in a structure comprising lining a structure with a composition comprising at least one aggregate and at least one phenolic resin, wherein said phenolic resin is pyrolyzed to result in the formation of a condensed ring glassy carbon, wherein said glassy carbon is a bonding matrix of the resulting composition, wherein said composition forms a chemical and thermal barrier in said structure, wherein said structure is used in a process utilizing high temperature salts, said high temperature salts in a liquid and/or gas form, and wherein said process comprises a corrosive, acidic or basic process environment.

20. The method of claim 19 including wherein said aggregate is at least one selected from the group consisting of LiF, ZrF₄, MgF₂, KF, MnF₂, NaF, YF₃, BaF₂, CaF₂, BaO, Al₂O₃, SiO2, CaO, TiO₂, Ti₂O₅, Ti₂O₃, TiO, ZrO₂, Y₂O₃, MgO carbon compounds, graphite, SiC, B₄C (B₁₂C₃), WC, BN, a rare earth oxide, an alkali halide, and an alkaline halide, and combinations thereof.

21. The method of claim 20 wherein said aggregate of said composition is CaO plus Al₂O₃.

22. The method of claim 20 wherein said aggregate of said composition is one of CaO-2Al₂O₃ (CaAlO₄), CaO—Al₂O₃, or CaO-6Al₂O₃, or combinations of one or more of CaO-2Al₂O₃ (CaAlO₄), CaO—Al₂O₃, and CaO-6Al₂O₃.

23. The method of claim 20 wherein said aggregate is a mixture of at least two or more of said aggregates.

24. The method of claim 20 wherein said alkali halide is at least one selected from the group consisting of LiCl, NaCl, and KCl, and corresponding fluoride (F), bromide (Br), or iodide (I) salts.

25. The method of claim 20 wherein said alkaline halide is at least one selected from the group consisting of MgCl₂, CaCl₂, SrCl₂, and BaCl₂, and corresponding fluoride (F), bromide (Br) and iodide (I) salts.

26. The method of claim 20 wherein said aggregate is at least one selected from the group consisting of LiF, ZrF₄, MgF₂, KF, NaF, YF₃, BaF₂, and CaF₂.

27. The method of claim 19 wherein said resin is at least one selected from the group consisting of a novolac resin, a resol resin, or a combination of a mixture of a novolac resin and a resole resin.

28. The method of claim 19 wherein said resin is a cross-linked phenolic resin.

29. The method of claim 19 wherein said resin is a cross-linked and pyrolyzed phenolic resin.

30. The method of claim 19 wherein said aggregate is at least one selected from the group consisting of a calcium aluminate (CA), tabular alumina, bubble alumina, magnesium oxide, alumina oxide, calcium hexaaluminate, silicon carbide, sintered 45-70% alumina, fused mullite, fused magnesium aluminate spinel, and dead burned (DB) magnesium oxide, and combinations thereof.

31. The method of claim 19 wherein said aggregate is at least one selected from the group consisting of LiF, ZrF₄, MgF₂, KF, MnF₂, NaF, YF₃, BaF₂, CaF₂, BaO, Al₂O₃, SiO2, CaO, TiO₂, Ti₂O₅, Ti₂O₃, TiO, ZrO₂, Y₂O₃, MgO carbon compound, graphite, SiC, B₄C (B₁₂C₃), WC, AlN, BN, a rare earth oxide, an alkali halide, an alkaline halide, calcium aluminate (CA), tabular alumina, bubble alumina, magnesium oxide, alumina oxide, calcium hexa-aluminate, silicon carbide, sintered 45-70% alumina, fused mullite, fused magnesium aluminate spinel, and dead burned (DB) magnesium oxide, and combinations thereof.

32. The method of claim 19 including wherein said glassy carbon protects said aggregate from said salt and corrosive environment of said process.
